(19) United States
(12) Patent Application Publication
(10) Pub. No.: US 2026/0175912 A1
(43) Pub. Date: Jun. 25, 2026

(54) STEERING SYSTEM FOR A GOLF VEHICLE

(71) Applicant: Textron Inc., Providence, RI (US)

(72) Inventors: Trevor Douglas Roebuck, Evans, GA (US); Baily Guyton Wood, Dublin, GA (US); Ricky Veldee Kemp, Augusta, GA (US)

(73) Assignee: Textron Inc., Providence, RI (US)

(21) Appl. No.: 18/986,966

(22) Filed: Dec. 19, 2024

(51) Int. Cl. B62D 7/14; B62D 7/15

(52) U.S. Cl. CPC B62D 7/142; B62D 7/1518; B62D 7/159

(57) ABSTRACT

A golf vehicle includes a chassis, a front tractive assembly coupled to the chassis, a rear tractive assembly coupled to the chassis, and a steering system. The steering system includes a front actuator assembly coupled to the front tractive assembly and a rear actuator assembly coupled to the rear tractive assembly. The front actuator assembly is configured to steer the front tractive assembly. The rear actuator assembly is configured to steer the rear tractive assembly.

### BACKGROUND

A golf vehicle may include a steering system that steers tractive elements of the golf vehicle. However, such steering systems may not be configured to simultaneously steer front tractive elements and rear tractive elements. The present application relates to steering systems for golf vehicles, and more specifically to drive-by-wire steering systems for golf carts that link front tractive elements and rear tractive elements of the golf carts to simultaneously steer the front tractive elements and the rear tractive elements.

### SUMMARY

One embodiment relates to a golf vehicle. The golf vehicle includes a chassis, a front tractive assembly coupled to the chassis, a rear tractive assembly coupled to the chassis, and a steering system. The steering system includes a front actuator assembly coupled to the front tractive assembly and a rear actuator assembly coupled to the rear tractive assembly. The front actuator assembly is configured to steer the front tractive assembly. The rear actuator assembly is configured to steer the rear tractive assembly.

Another embodiment relates to a recreational vehicle. The recreational vehicle includes a chassis, a front tractive assembly including a first tractive element and a second tractive element, a rear tractive assembly including a third tractive element and a fourth tractive element, and a steering system. The steering system includes a first movable body movable between a first position and a second position, a first bar coupled to a first end of the first movable body, a first steering knuckle pivotably coupled to the chassis, pivotably coupled to the first bar, and coupled to the first tractive element, a second bar coupled to an opposing second end of the first movable body, a second steering knuckle pivotably coupled to the chassis, pivotably coupled to the second bar, and coupled to the second tractive element, a second movable body movable between a third position and a fourth position, a third bar coupled to a first end of the second movable body, a third steering knuckle pivotably coupled to the chassis, pivotably coupled to the third bar, and coupled to the third tractive element, a fourth bar coupled to an opposing second end of the second movable body, and a fourth steering knuckle pivotably coupled to the chassis, pivotably coupled to the fourth bar, and coupled to the fourth tractive element.

Still another embodiment relates to a steering system for a vehicle. The steering system includes a first actuator assembly, a second actuator assembly, a first steering assembly, a second steering assembly, a third steering assembly, and a fourth steering assembly. The first steering assembly is coupled to the first actuator assembly and configured to couple to a first front tractive element of the vehicle on a first side of the vehicle. The second steering assembly is coupled to the first actuator assembly and configured to couple to a second front tractive element of the vehicle on an opposing second side of the vehicle. The third steering assembly is coupled the second actuator assembly and configured to couple to a first rear tractive element of the vehicle on the first side of the vehicle. The fourth steering assembly is coupled to the second actuator assembly and configured to couple to a second rear tractive element of the vehicle on the opposing second side of the vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a top view of a steering system of the vehicle of FIG. 1 in a first configuration, according to an exemplary embodiment.

FIG. 4 is a top view of the steering system of FIG. 3 in a second configuration, according to an exemplary embodiment.

FIG. 5 is a steering plate of the steering system of FIG. 3, according to an exemplary embodiment.

FIG. 6 is a top view of a steering system of the vehicle of FIG. 1 in a first configuration, according to another exemplary embodiment.

FIG. 7 is a top view of the steering system of FIG. 6 in a second configuration, according to an exemplary embodiment.

FIG. 8 is a top view of the steering system of FIG. 6 in a third configuration, according to an exemplary embodiment.

FIG. 9 is a top view of a steering system of the vehicle of FIG. 1 in a first configuration, according to another exemplary embodiment.

FIG. 10 is a top view of the steering system of FIG. 9 in a second configuration, according to an exemplary embodiment.

FIG. 11 is a top view of the steering system of FIG. 9 in a third configuration, according to an exemplary embodiment.

FIG. 12 is a detailed top view of the steering system of FIG. 9 in the third configuration, according to an exemplary embodiment.

FIG. 13 is a section view of an actuator assembly of the steering system of any one of FIGS. 3, 6, or 9, according to an exemplary embodiment.

FIG. 14 is a schematic block diagram of a fleet monitoring and control system including a plurality of the vehicles of FIG. 1, according to an exemplary embodiment.

FIG. 15 is a flow chart of a method for operating the steering system of any one of FIGS. 3, 6, or 9, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

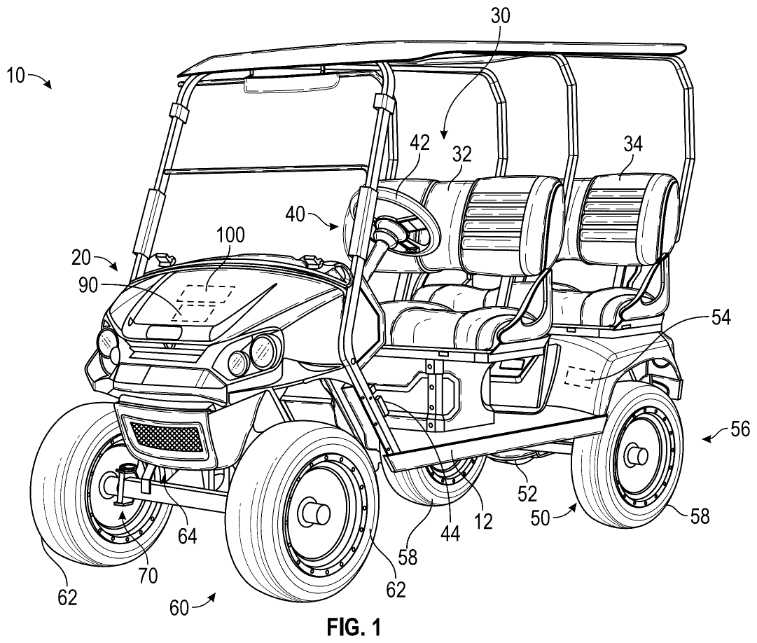

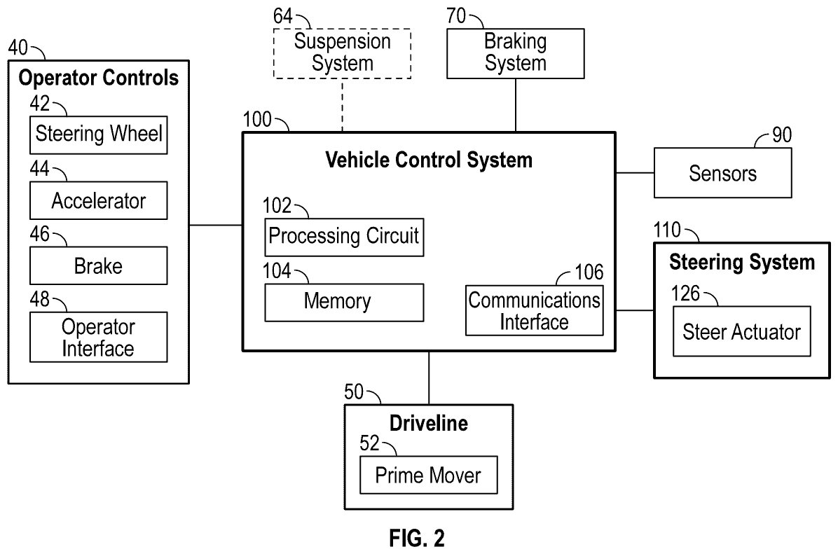

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input devices and operator output devices, shown as operator controls 40, that are disposed within the occupant seating area 30; a drivetrain, shown as driveline 50, coupled to the frame 12 and at least partially disposed under the body 20; a vehicle suspension system, shown as suspension system 64, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 64, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, another type of chore product that may be used on a golf course, a ground support equipment (“GSE”) that may be used at an airport, and/or still other off-road machines or vehicles.

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc. In other embodiments, at least one of the operator controls 40 is disposed outside of the occupant seating area 30.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 60. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes first tractive elements, shown as rear tractive elements 58, and the front tractive assembly 60 includes second tractive elements, shown as front tractive elements 62 that are configured as wheels. In some embodiments, the rear tractive elements 58 and/or the front tractive elements 62 are configured as tracks.

According to an exemplary embodiment, the prime mover 52 is configured to provide power to drive the rear tractive assembly 56 and/or the front tractive assembly 60 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 60. The rear tractive assembly 56 and/or the front tractive assembly 60 may include a drive shaft, a differential, and/or an axle. In some embodiments, the rear tractive assembly 56 and/or the front tractive assembly 60 include two axles or a tandem axle arrangement. In some embodiments, the rear tractive assembly 56 and/or the front tractive assembly 60 are steerable (e.g., using the steering wheel 42).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 60. By way of another example, the driveline 50 may include a first prime mover 52 that drives a first one of the front tractive elements 62, a second prime mover 52 that drives a second one of the front tractive elements 62, a third prime mover 52 that drives a first one of the rear tractive elements 58, and/or a fourth prime mover 52 that drives a second one of the rear tractive elements 58. By way of still another example, the driveline 50 may include a first prime mover 52 that drives the front tractive assembly 60, a second prime mover 52 that drives a first one of the rear tractive elements 58, and a third prime mover 52 that drives a second one of the rear tractive elements 58. By way of yet another example, the driveline 50 may include a first prime mover 52 that drives the rear tractive assembly 56, a second prime mover 52 that drives a first one of the front tractive elements 62, and a third prime mover 52 that drives a second one of the front tractive elements 62.

According to an exemplary embodiment, the suspension system 64 includes one or more suspension components (e.g., shocks, dampers, springs, etc.) positioned between the frame 12 and one or more components (e.g., tractive elements, axles, etc.) of the rear tractive assembly 56 and/or the front tractive assembly 60. In some embodiments, the vehicle 10 does not include the suspension system 64.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 60 (e.g., the front axle, the front tractive elements 62, etc.) and (ii) one or more rear braking components positioned to facilitate braking one or more components of the rear tractive assembly 56 (e.g., the rear axle, the rear tractive elements 58, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements 62. In some embodiments, the one or more rear braking components include two rear braking components, one positioned to facilitate braking each of the rear tractive elements 58. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 64, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102 (e.g., one or more processing circuits, etc.), a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Drive-by-Wire Steering System

As shown in FIG. 2, the vehicle 10 includes a drive-by-wire steering system (e.g., electronic steering system, wire controlled steering system, non-mechanical steering system, etc.), shown as steering system 110, coupled to the rear tractive assembly 56 and the front tractive assembly 60. The vehicle control system 100 is configured to operate the steering system 110 to steer the rear tractive assembly 56 and the front tractive assembly 60 based on inputs (e.g., user inputs, control inputs, steering inputs, steering data, etc.) received by the vehicle control system 100 without mechanically linking (e.g., mechanically coupling, etc.) the rear tractive assembly 56 or the front tractive assembly 60 to the operator controls 40 (e.g., the steering wheel 42). By way of example, the vehicle control system 100 may receive steering inputs digitally and may provide digital control signals to the steering system 110 to steer the rear tractive assembly 56 and the front tractive assembly 60. As a result, the operator controls 40 may not be mechanically linked to the rear tractive assembly 56 or the front tractive assembly 60 and may be positioned in locations that would not be possible if the operator controls 40 were mechanically linked to the rear tractive assembly 56 and/or the front tractive assembly 60 (e.g., disposed outside of the occupant seating area 30, etc.).

In some embodiments, the vehicle control system 100 is configured to operate the steering system 110 to simultaneously steer the rear tractive assembly 56 and the front tractive assembly 60 based on inputs received by the vehicle control system 100 without mechanically linking the rear tractive assembly 56 or the front tractive assembly 60 to the operator controls 40. The steering system 110 may simultaneously steer the rear tractive assembly 56 and the front tractive assembly 60 by coupling (e.g., linking, connecting, etc.) the rear tractive assembly 56 to the front tractive assembly 60 such that the steering of the rear tractive assembly 56 corresponds to the steering of the front tractive assembly 60. By way of example, the steering system 110 may simultaneously steer the front tractive assembly 60 in a first direction and the rear tractive assembly 56 in a second opposing direction such that the vehicle 10 is steered in the first direction when the vehicle 10 is traveling in a forward direction. As a result of the front tractive assembly 60 being steered in the first direction and the rear tractive assembly 56 being steered in the second direction, a turning radius of the vehicle 10 may be decreased compared to if only the front tractive assembly 60 is steered in the first direction or only the rear tractive assembly 56 is steered in the second opposing direction. By decreasing the turning radius of the vehicle 10, an area utilized by the vehicle 10 during a turning maneuver may be decreased and a maneuverability of the vehicle 10 may be increased.

According to an exemplary embodiment, the steering system 110 is configured to steer the rear tractive assembly 56 and the front tractive assembly 60 based on steering inputs received by the operator controls 40. By way of example, when the operator of the vehicle 10 turns the steering wheel 42, one of the sensors 90 (e.g., a steering sensor, etc.) may generate steering data corresponding to an orientation of the steering wheel 42 and provide the steering data to the vehicle control system 100. The vehicle control system 100 may generate control signals for the steering system 110 based on the steering data and may provide the control signals to the steering system 110 that cause the steering system 110 to steer the rear tractive assembly 56 and the front tractive assembly 60 such that the rear tractive assembly 56 and the front tractive assembly 60 are steered by the steering system 110 based on the orientation of the steering wheel 42. As a result, the steering system 110 may steer the rear tractive assembly 56 and the front tractive assembly 60 based on inputs received by the operator controls 40 to coordinate the steering of the rear tractive assembly 56 and the front tractive assembly 60. Additionally, or alternatively, the steering system 110 may allow for the vehicle control system 100 to control the steering of the rear tractive assembly 56 and the front tractive assembly 60 by providing control signals to the steering system 110, which may facilitate the vehicle control system 100 autonomously and/or semi-autonomously steering the rear tractive assembly 56 and the front tractive assembly 60. In some embodiments, the steering system 110 is configured to simultaneously steer the rear tractive assembly 56 and the front tractive assembly 60 based on the steering inputs received by the operator controls 40.

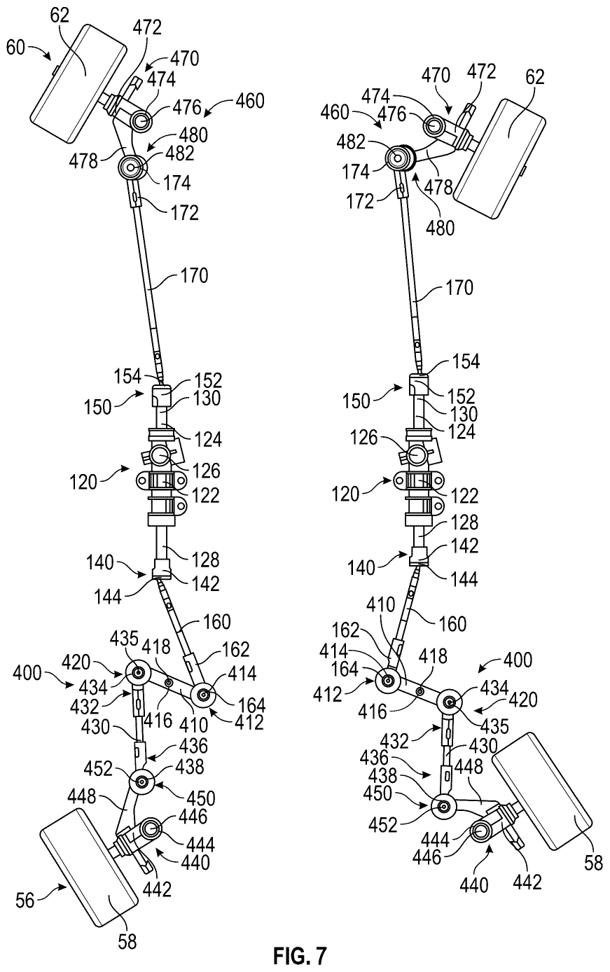

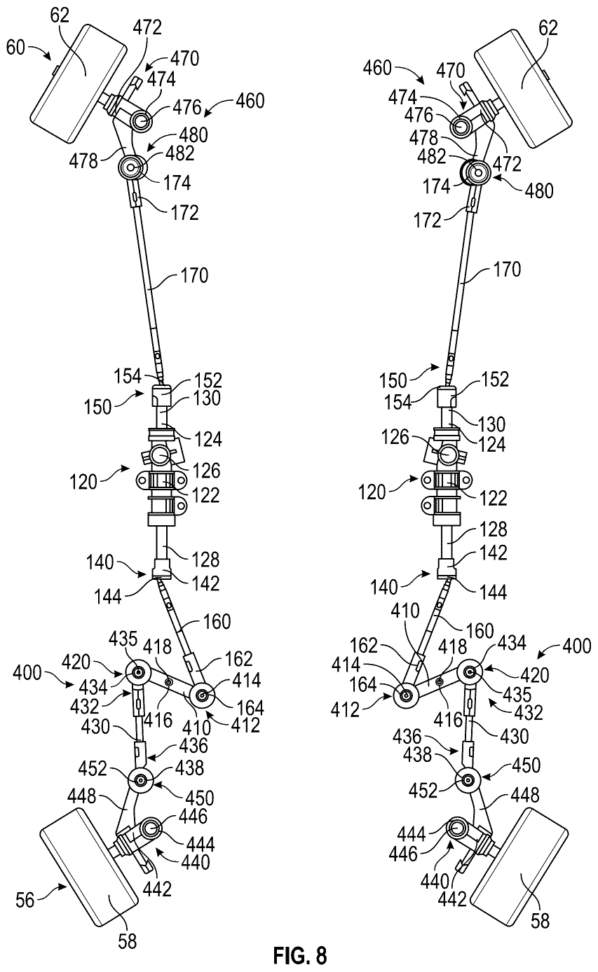

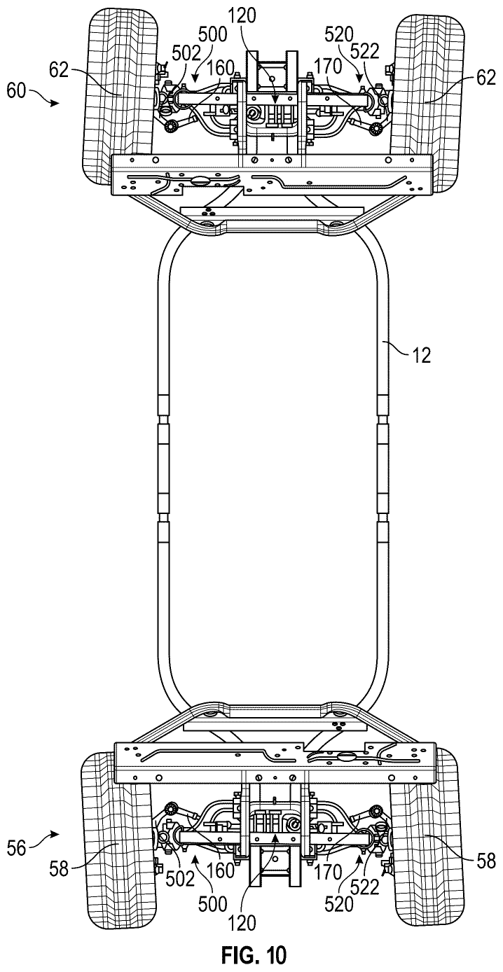

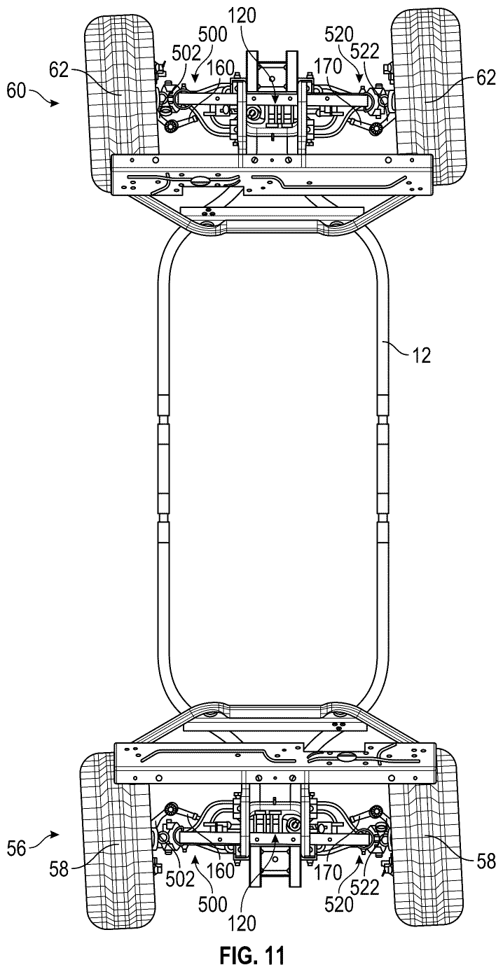

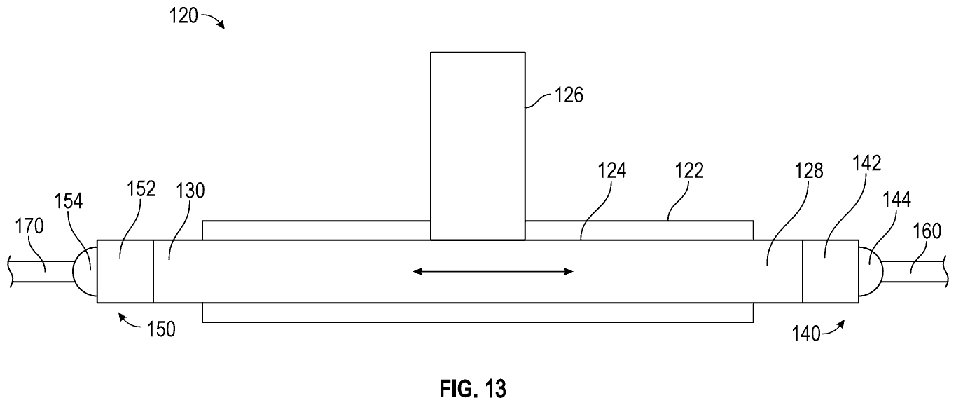

As shown in FIGS. 2-4 and 6-13, the steering system 110 includes at least one actuator system, shown as actuator assembly 120, communicably coupled to the vehicle control system 100. The actuator assembly 120 is configured to operate the steering system 110 to steer the rear tractive assembly 56 and to steer the front tractive assembly 60. By way of example, the actuator assembly 120 may receive control signals from the vehicle control system 100 corresponding to steering of the rear tractive assembly 56 and the front tractive assembly 60 and may operate the steering system 110 to steer the rear tractive assembly 56 and to steer the front tractive assembly 60. In some embodiments, the steering system 110 includes a plurality of the actuator assemblies 120 configured to operate the steering system 110 to steer the rear tractive assembly 56 and to steer the front tractive assembly 60. In other embodiments, the steering system 110 includes more or fewer components.

As shown in FIGS. 2-4 and 6-13, the actuator assembly 120 includes a housing, shown as actuator housing 122, a body, shown as movable body 124, at least partially received within the actuator housing 122, an actuator (e.g., a piston, a motor, etc.), shown as steer actuator 126, coupled to the actuator housing 122 and the movable body 124, a first ball joint, shown as first ball joint 140, coupled to a first end, shown as first end 128, of the movable body 124, a second ball joint, shown as second ball joint 150, coupled to a second end (e.g., a second opposing end, etc.), shown as second end 130, of the movable body 124, a first bar, shown as first pushbar 160, coupled to the first ball joint 140, and a second bar, shown as second pushbar 170, coupled to the second ball joint 150.

According to an exemplary embodiment, the actuator housing 122 is configured to couple to the frame 12 of the vehicle 10 (e.g., with fasteners). The steer actuator 126 is configured to move the movable body 124 relative to the actuator housing 122 to operate the steering system 110 to steer the front tractive assembly 60 and to steer the rear tractive assembly 56. By way of example, the steer actuator 126 may move the movable body 124 in a first direction to operate the steering system 110 to steer the front tractive assembly 60 and to steer the rear tractive assembly 56. By way of another example, the movable body 124 may be slidably coupled to the actuator housing 122 and the steer actuator 126 may drive the movable body 124 to slide in a first direction relative to the actuator housing 122 and to slide in a second direction relative to the actuator housing 122 to operate the steering system 110 to steer the rear tractive assembly 56 and to steer the front tractive assembly 60. In some embodiments, the vehicle control system 100 is configured to selectively engage, selectively disengage, control, or otherwise communicate with the steer actuator 126 (e.g., via the communications interface 106, a controller area network (“CAN”) bus, etc.). By way of example, the vehicle control system 100 may send and receive signals (e.g., control signals, location signals, etc.) with the steer actuator 126 to operate the steering system 110 to steer the rear tractive assembly 56 and the front tractive assembly 60. In some embodiments, the actuator assembly 120 includes a plurality of steer actuators 126 configured to move the movable body 124 relative to the actuator housing 122.

The movable body 124 may be moveable between a first position (e.g., a forward position, a left position, etc.) and a second position (e.g., a rearward position, a right position, etc.). When the movable body 124 is moved by the steer actuator 126 toward the first position or the second position, the movable body 124 may operate the steering system 110 to steer the rear tractive assembly 56 and to steer the front tractive assembly 60. In some embodiments, the movable body 124 is movable into an intermediate position (e.g., a third position, etc.) between the first position and the second position (e.g., halfway between the first position and the second position, etc.).

According to an exemplary embodiment, the actuator assembly 120 is a rack-and pinion actuator assembly. By way of example, the movable body 124 may include a rack (e.g., a toothed rack, a rack gear, etc.) and the steer actuator 126 may include a motor and a pinion (e.g., a pinion gear, a circular gear, etc.) that engages the rack of the movable body 124. When the motor of the steer actuator 126 drives the pinion, the engagement between the pinion and the rack of the movable body 124 moves the movable body 124 linearly relative to the steer actuator 126 and the actuator housing 122. As a result, when the motor of the steer actuator 126 drives the pinion in a first rotational direction, the engagement between the pinion of the steer actuator 126 and the rack of the movable body 124 may move the movable body 124 toward the first position and when the motor of the steer actuator 126 drives the pinion in a second rotational direction (e.g., a second opposing rotational direction, etc.), the engagement between the pinion of the steer actuator 126 and the rack of the movable body 124 may move the movable body 124 toward the second position.

In some embodiments, at least one of the sensors 90 is configured to acquire steering feedback data regarding the operation of the actuator assembly 120. By way of example, the at least one of the sensors 90 may include a position sensor to facilitate acquiring the steering feedback data regarding a position of the movable body 124 relative to the actuator housing 122. The vehicle control system 100 may receive the position data from the at least one of the sensors 90 to determine a configuration of the steering system 110 and/or orientations of the front tractive elements 62 and the rear tractive elements 58.

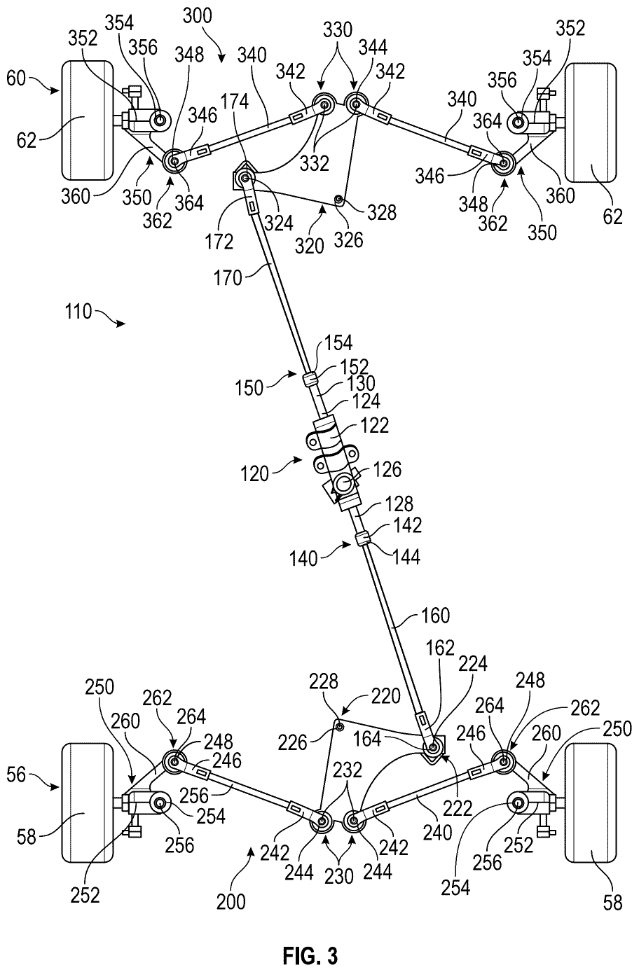

As shown in FIGS. 3, 4, and 6-13, the first ball joint 140 includes a first socket, shown as first socket 142, coupled to the first end 128 of the movable body 124, and a first ball, shown as first ball 144, rotatably coupled to the first socket 142 and coupled to a first end (e.g., a forward end, etc.) of the first pushbar 160. By way of example, the first ball 144 may be received by the first socket 142 and allowed to rotate relative to the first socket 142. As a result, as the movable body 124 drives the steering system 110, the first pushbar 160 may pivot relative to the movable body 124 via the first ball joint 140. In other embodiments, the first ball 144 is coupled to the first end 128 of the movable body 124 and the first socket 142 is coupled to the first end of the first pushbar 160.

As shown in FIGS. FIGS. 3, 4, and 6-13, the second ball joint 150 includes a second socket, shown as second socket 152, coupled to the second end 130 of the movable body 124, and a second ball, shown as second ball 154, rotatably coupled to the second socket 152 and coupled to a first end (e.g., a rearward end, etc.) of the second pushbar 170. By way of example, the second ball 154 may be received by the second socket 152 and allowed to rotate relative to the second socket 152. As a result, as the movable body 124 drives the steering system 110, the second pushbar 170 may pivot relative to the movable body 124 via the second ball joint 150. In other embodiments, the second ball 154 is coupled to the second end 130 of the movable body 124 and the second socket 152 is coupled to the first end of the second pushbar 170. As shown in FIGS. 3, 4, and 6-12, a second end (e.g., a rear end, a left end, etc.) of the first pushbar 160, shown as first pushbar second end 162, defines a first aperture, shown as first pushbar aperture 164, extending through the first pushbar 160. As shown in FIGS. 3, 4, and 6-12, a second end (e.g., a front end, a right end, etc.) of the second pushbar 170, shown as second pushbar second end 172, defines a second aperture, shown as second pushbar aperture 174 extending through the second pushbar 170.

### Linked Front-Rear Drive-by-Wire Steering System

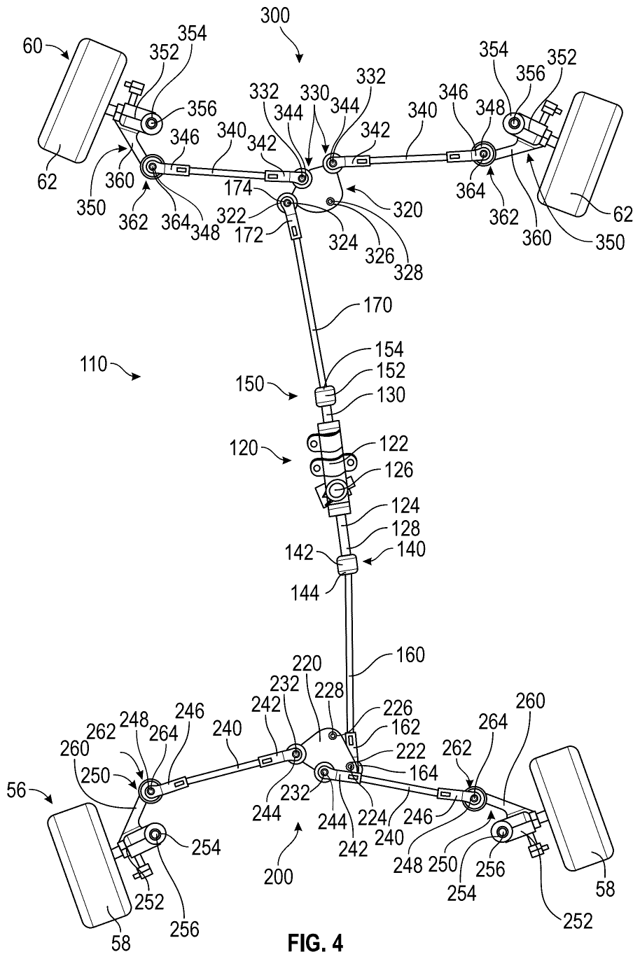

According to the exemplary embodiment shown in FIGS. 3 and 4, the steering system 110 (e.g., a linked drive-by-wire steering system, a simultaneous drive-by-wire steering system, etc.) includes a first steering assembly, shown as rear steering assembly 200, coupled between the actuator assembly 120 and the rear tractive elements 58 of the rear tractive assembly 56, and a second steering assembly, shown as front steering assembly 300, coupled between the actuator assembly 120 and the front tractive elements 62 of the front tractive assembly 60. The actuator assembly 120 is configured to operate the rear steering assembly 200 to steer the rear tractive assembly 56 and the front steering assembly 300 to steer the front tractive assembly 60. The actuator assembly 120 is configured to operate the rear steering assembly 200 and the front steering assembly 300 to simultaneously steer the rear tractive assembly 56 and the front tractive assembly 60. By way of example, the actuator assembly 120 may receive control signals from the vehicle control system 100 corresponding to steering of the rear tractive assembly 56 and the front tractive assembly 60 and may simultaneously operate the rear steering assembly 200 to steer the rear tractive assembly 56 and operate the front steering assembly 300 to the front tractive assembly 60. The steer actuator 126 is configured to move the movable body 124 relative to the actuator housing 122 to simultaneously operate the front steering assembly 300 to steer the front tractive assembly 60 and the rear steering assembly 200 to steer the rear tractive assembly 56. By way of example, the steer actuator 126 may move the movable body 124 in a first direction to drive the front steering assembly 300 to steer the front tractive assembly 60 and to drive the rear steering assembly 200 to steer the rear tractive assembly 56. By way of another example, the movable body 124 may be slidably coupled to the actuator housing 122 and the steer actuator 126 may drive the movable body 124 to slide in a first direction relative to the actuator housing 122 and to slide in a second direction relative to the actuator housing 122 to operate the rear steering assembly 200 to steer the rear tractive assembly 56 and the front steering assembly 300 to steer the front tractive assembly 60.

When the movable body 124 is moved by the steer actuator 126 toward the first position, the movable body 124 may operate the rear steering assembly 200 to steer the rear tractive assembly 56 towards a first direction (e.g., to the right, etc.) and the front steering assembly 300 to steer the front tractive assembly 60 towards a second direction (e.g., to the left, etc.), the second direction being opposite the first direction. As a result of the rear tractive assembly 56 being steered toward the first direction and the front tractive assembly 60 being steered toward the second direction, the vehicle 10 may turn toward the second direction when the movable body 124 is in the first position and the vehicle 10 is driving forward. When the movable body 124 is moved by the steer actuator 126 toward the second position, the movable body 124 may operate the front steering assembly 300 to steer the front tractive assembly 60 towards the first direction and the rear steering assembly 200 to steer the rear tractive assembly 56 towards the second direction. As a result of the rear tractive assembly 56 being steered toward the second direction and the front tractive assembly 60 being steered toward the first direction, the vehicle 10 may turn toward the first direction when the movable body 124 is in the second position and the vehicle 10 is driving forward.

When the movable body 124 is in the intermediate position, the rear steering assembly 200 and the front steering assembly 300 may steer the rear tractive assembly 56 and the front tractive assembly 60 in a same direction (e.g., straight forward, straight ahead, etc.). When the movable body 124 is moved by the steer actuator 126 from the intermediate position toward the first position, the rear steering assembly 200 may steer the rear tractive assembly 56 in the first direction and the front steering assembly 300 may steer the front tractive assembly 60 in the second direction. When the movable body 124 is moved by the steer actuator 126 from the intermediate position toward the second position, the front steering assembly 300 may steer the front tractive assembly 60 in the first direction and the rear steering assembly 200 may steer the rear tractive assembly 56 in the second direction.

As shown in FIGS. 3 and 4, the rear steering assembly 200 includes a first plate, shown as rear pivot plate 220, pivotably coupled to the frame 12 and pivotably coupled to the first pushbar 160 (e.g., a rear pushbar, etc.), a plurality of (e.g., two) first tie bars, shown as rear tie rods 240, pivotably coupled to the rear pivot plate 220, and a plurality of (e.g., two) first steering bodies, shown as rear steering knuckles 250, each (a) coupled to one of the rear tractive elements 58, (b) pivotably coupled to one of the rear tie rods 240, and (c) pivotably coupled to the frame 12. The movement of the movable body 124 drives the rear steering assembly 200 to pivot the rear tractive elements 58 relative to the frame 12 to steer the rear tractive assembly 56. By way of example, when the actuator assembly 120 moves the movable body 124 rearward toward the second position, the movable body 124 may move the first ball joint 140 (e.g., a rear ball joint, etc.) and the first pushbar 160 rearward. The movement of the first pushbar 160 causes the rear pivot plate 220 to pivot relative to the frame 12, which pushes a first of the rear tie rods 240 in a first direction (e.g., leftward, etc.) and pulls a second of the rear tie rods 240 in the first direction. The movement of the rear tie rods 240 causes the rear steering knuckles 250 to pivot the rear tractive elements 58 relative to the frame 12 towards the first direction to steer the rear tractive assembly 56.

As shown in FIGS. 3 and 4, the first pushbar aperture 164 is configured to pivotably couple the first pushbar 160 to the rear pivot plate 220 (e.g., via a fastener, etc.). As shown in FIGS. 3-5, the rear pivot plate 220 defines a third aperture, shown as rear pivot plate first aperture 222, extending through the rear pivot plate 220. The rear pivot plate first aperture 222 is configured to align with the first pushbar aperture 164 of the first pushbar 160 to selectively receive a first fastener (e.g., a bolt, a pin, an anchor, etc.), shown as rear pivot plate first fastener 224, to pivotably couple the first pushbar 160 to the rear pivot plate 220.

As shown in FIGS. 3-5, the rear pivot plate 220 defines a fourth aperture, shown as rear pivot plate second aperture 226, extending through the rear pivot plate 220. The rear pivot plate second aperture 226 is configured to align with a first frame aperture defined by the frame 12 to selectively receive a second fastener, shown as rear pivot plate second fastener 228, to pivotably couple the rear pivot plate 220 to the frame 12. By way of example, the rear pivot plate 220 may pivot relative to the frame 12 about the rear pivot plate second aperture 226 when the movable body 124 moves between the first position and the second position to move the first pushbar 160. When the movable body 124 moves toward the first position, the first pushbar 160 may cause the rear pivot plate 220 to pivot about the rear pivot plate second aperture 226 in a first direction (e.g., a counter-clockwise direction, etc.) and, when the movable body 124 moves toward the second position, the first pushbar 160 may cause the rear pivot plate 220 to pivot about the rear pivot plate second aperture 226 in a second opposing direction (e.g., a clockwise direction, etc.).

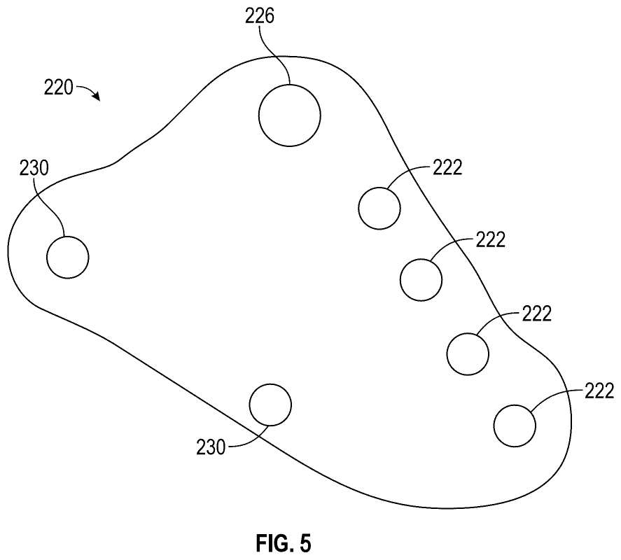

As shown in FIG. 5, the rear pivot plate 220 defines a first plurality of apertures, shown as rear pivot plate third apertures 230, extending through the rear pivot plate 220. The rear pivot plate third apertures 230 are each configured to pivotably couple the rear pivot plate 220 to one of the rear tie rods 240 (e.g., via fasteners, etc.). By way of example, a first of the rear pivot plate third apertures 230 may be configured to pivotably couple the rear pivot plate 220 to a first of the rear tie rods 240 and a second of the rear pivot plate third apertures 230 may be configured to pivotably couple the rear pivot plate 220 to a second of the rear tie rods 240. According to an exemplary embodiment, each of the rear pivot plate third apertures 230 are equidistant from the rear pivot plate second aperture 226. By way of example, a first of the rear pivot plate third apertures 230 configured to pivotably couple the rear pivot plate 220 to a first of the rear tie rods 240 and a second of the rear pivot plate third apertures 230 configured to pivotably couple the rear pivot plate 220 to a second of the rear tie rods 240 may be an equal distance from the rear pivot plate second aperture 226. As a result, the rear pivot plate third apertures 230 may each pivot a same distance (e.g., a same arced distance, etc.) around the rear pivot plate second aperture 226 as the first pushbar 160 pivots the rear pivot plate 220 about the rear pivot plate second aperture 226 to allow for the rear steering assembly 200 to pivot a first of the rear tractive elements 58 corresponding to the first of the rear tie rods 240 the same amount (e.g., a same angle, etc.) as a second of the rear tractive elements 58 corresponding to the second of the rear tie rods 240.

As shown in FIGS. 3 and 4, first ends (e.g., inward ends, etc.) of the rear tie rods 240, shown as rear tie rod interior ends 242, define fifth apertures, shown as rear tie rod first apertures 244, extending through the rear tie rod interior ends 242 of the rear tie rods 240. The rear tie rod first apertures 244 are each configured to selectively align with one of the rear pivot plate third apertures 230 to receive a third fastener, shown as rear pivot plate third fastener 232, to pivotably couple the rear tie rods 240 to the rear pivot plate 220. As shown in FIGS. 3 and 4, second ends (e.g., outward ends, etc.) of the rear tie rods 240, shown as rear tie rod exterior ends 246, define sixth apertures, shown as rear tie bar second apertures 248, extending through the rear tie rod exterior ends 246 of the rear tie rods 240. Each of the rear tie bar second apertures 248 are configured to pivotably couple each of the rear tie rods 240 to one of the rear steering knuckles 250 (e.g., via fasteners, etc.).

As shown in FIGS. 3 and 4, each of the rear steering knuckles 250 include a first portion, shown as rear main body portion 252, coupled to one of the rear tractive elements 58, and a second portion, shown as rear arm portion 260, extending from the rear main body portion 252. As shown in FIGS. 3 and 4, each of the rear main body portions 252 defines a seventh aperture, shown as rear main body aperture 254, extending through the rear main body portion 252 of the rear steering knuckle 250. The rear main body apertures 254 are configured to align with second frame apertures defined by the frame 12 to selectively receive fourth fasteners, shown as rear main body fasteners 256, to pivotably couple the rear steering knuckles 250 to the frame 12. By way of example, the rear steering knuckles 250 may pivot relative to the frame 12 about the rear main body apertures 254 when the movable body 124 moves between the first position and the second position to move the first pushbar 160. When the movable body 124 moves toward the first position, the first pushbar 160 causes the rear pivot plate 220 to pivot about the rear pivot plate second aperture 226 in the first direction (e.g., counter-clockwise, etc.), the pivoting of the rear pivot plate 220 moves the rear tie rods 240, and the movement of the rear tie rods 240 causes the rear steering knuckles 250, and thus the rear tractive elements 58, to pivot about the rear main body apertures 254 in the second opposing direction (e.g., clockwise, etc.) such that the rear steering knuckles 250 and the rear tractive elements 58 are pivoted in an opposite direction from the rear pivot plate 220. When the movable body 124 moves toward the second position, the first pushbar 160 causes the rear pivot plate 220 to pivot about the rear pivot plate second aperture 226 in the second opposing direction (e.g., clockwise, etc.), the pivoting of the rear pivot plate 220 moves the rear tie rods 240, and the movement of the rear tie rods 240 causes the rear steering knuckles 250, and thus the rear tractive elements 58, to pivot about the rear main body apertures 254 in the first direction (e.g., counter-clockwise, etc.) such that the rear steering knuckles 250 and the rear tractive elements 58 are pivoted in an opposite direction from the rear pivot plate 220. In some embodiments, the suspension system 64 is coupled to the rear steering knuckles 250.

As shown in FIGS. 3 and 4, the rear arm portions 260 define eighth apertures, shown as rear arm apertures 262, extending through the rear arm portions 260 of the rear steering knuckles 250. The rear arm apertures 262 are each configured to align with one of the rear tie bar second apertures 248 to selectively receive a fifth fastener, shown as rear arm fasteners 264, to pivotably couple each of the rear steering knuckles 250 to one of the rear tie rods 240. By way of example, when the movable body 124 moves the first pushbar 160 to pivot the rear pivot plate 220 about the rear pivot plate second aperture 226, the resulting movement of the rear tie rods 240 may pivot the rear steering knuckles 250 about the rear main body apertures 254 through the rear arm fasteners 264.

According to the exemplary embodiment shown in FIG. 5, the rear pivot plate 220 defines a plurality of the rear pivot plate first apertures 222 extending through the rear pivot plate 220. The first pushbar aperture 164 may selectively align with any one of the rear pivot plate first apertures 222 to receive the rear pivot plate first fastener 224 to pivotably couple the first pushbar 160 to the rear pivot plate 220. Each of the rear pivot plate first apertures 222 may be spaced a different distance away from the rear pivot plate second aperture 226. As a result of the rear pivot plate first apertures 222 being spaced different distances away from the rear pivot plate second aperture 226, the rear pivot plate first apertures 222 may allow for the rear steering assembly 200 to have different rear steering configurations that allow for different relationships between movement of the movable body 124 and pivoting of the rear tractive elements 58 of the rear tractive assembly 56. By way of example, when the first pushbar aperture 164 selectively aligns with a first of the rear pivot plate first apertures 222 spaced a first distance from the rear pivot plate second aperture 226, the movable body 124 moving a first amount may cause the rear tractive elements 58 to pivot a first angle relative to the frame 12. However, when the first pushbar aperture 164 selectively aligns with a second of the rear pivot plate first apertures 222 spaced a second distance from the rear pivot plate second aperture 226 and the second distance is different than the first distance, the movable body 124 moving the first amount may cause the rear tractive elements 58 to pivot a second angle relative to the frame 12 that is different than the first angle. Different relationships between the movement of the movable body 124 and the pivoting of the rear tractive elements 58 of the rear tractive assembly 56 may be desired by the operator of the vehicle 10 in order to adjust the performance of the vehicle 10 (e.g., decrease a turning radius of the rear tractive assembly 56, increase a turning radius of the rear tractive assembly 56, etc.).

In other embodiments, the rear pivot plate 220 defines a plurality of the rear pivot plate second apertures 226 configured to selectively align with the frame aperture of the frame 12 to receive the rear pivot plate second fastener 228 to pivotably couple the rear pivot plate 220 to the frame 12. Each of the rear pivot plate second apertures 226 may be spaced a different distance from the rear pivot plate first aperture 222. As a result, the rear pivot plate second apertures 226 may allow for the rear steering assembly 200 to be configured with different relationships between movement of the movable body 124 and pivoting of the rear tractive elements 58 of the rear tractive assembly 56. In still other embodiments, the rear pivot plate 220 defines a first plurality of the rear pivot plate third apertures 230 configured to selectively align with the rear tie rod first apertures 244 of a first of the rear tie rods 240 to receive the rear pivot plate third fastener 232 to pivotably couple the first of the rear tie rods 240 to the rear pivot plate 220 and a second plurality of the rear pivot plate third apertures 230 configured to selectively align with the rear tie rod first apertures 244 of a second of the rear tie rods 240 to receive the rear pivot plate third fastener 232 to pivotably couple the second of the rear tie rods 240 to the rear pivot plate 220. Each of the rear pivot plate third apertures 230 of the first plurality of the rear pivot plate third apertures 230 may be spaced a different distance from the rear pivot plate second aperture 226 and each of the rear pivot plate third apertures 230 of the second plurality of the rear pivot plate third apertures 230 may be spaced a different distance from the rear pivot plate second aperture 226. As a result, the first plurality of the rear pivot plate third apertures 230 and the second plurality of the rear pivot plate third apertures 230 may allow for the rear steering assembly 200 to be configured with different relationships between movement of the movable body 124 and pivoting of the rear tractive elements 58 of the rear tractive assembly 56.

In some embodiments, the rear pivot plate 220 is configured as a modular pivot plate that can be replaced by another pivot plate. By way of example, while operating the vehicle 10, the relationships between the movement of the movable body 124 and the pivoting of the rear tractive elements 58 of the rear tractive assembly 56 may result in turning characteristics of the vehicle 10 that are undesirable (e.g., too sharp of turns, too gradual of turns, etc.). By configuring the rear pivot plate 220 as a modular pivot plate, a first of the rear pivot plates 220 with a first configuration (e.g., a first arrangement of the rear pivot plate first apertures 222, the rear pivot plate second aperture 226, and/or the rear pivot plate third apertures 230, etc.) may be replaced with a second of the rear pivot plates 220 with a second configuration (e.g., a second arrangement of the rear pivot plate first apertures 222, the rear pivot plate second aperture 226, and/or the rear pivot plate third apertures 230, etc.) to change the turning characteristics of the vehicle 10.

As shown in FIGS. 3 and 4, the front steering assembly 300 includes a second plate, shown as front pivot plate 320, pivotably coupled to the frame 12 and pivotably coupled to the second pushbar 170, a plurality of (e.g., two) second tie bars, shown as front tie rods 340, pivotably coupled to the front pivot plate 320, and a plurality of (e.g., two) second steering bodies, shown as front steering knuckles 350, each (a) coupled to one of the front tractive elements 62, (b) pivotably coupled to one of the front tie rods 340, and (c) pivotably coupled to the frame 12. The movement of the movable body 124 drives the front steering assembly 300 to pivot the front tractive elements 62 relative to the frame 12 to steer the front tractive assembly 60. By way of example, when the actuator assembly 120 moves the movable body 124 forward toward the first position, the movable body 124 may move the second ball joint 150 and the second pushbar 170 forward. The movement of the second pushbar 170 causes the front pivot plate 320 to pivot relative to the frame 12, which pushes a first of the front tie rods 340 in a second direction (e.g., rightward, etc.) and pulls a second of the front tie rods 340 in the second direction. The movement of the front tie rods 340 causes the front steering knuckles 350 to pivot the front tractive elements 62 relative to the frame 12 toward the second direction to steer the front tractive assembly 60.

As shown in FIGS. 3 and 4, the second pushbar aperture 174 is configured to pivotably couple the second pushbar 170 to the front pivot plate 320 (e.g., via a fastener, etc.). As shown in FIGS. 3 and 4, the front pivot plate 320 defines a ninth aperture, shown as first front pivot plate aperture 322, extending through the front pivot plate 320. The first front pivot plate aperture 322 is configured to align with the second pushbar aperture 174 of the second pushbar 170 to selectively receive a sixth fastener (e.g., a bolt, a pin, an anchor, etc.), shown as front pivot plate first fastener 324, to pivotably couple the second pushbar 170 to the front pivot plate 320.

As shown in FIGS. 3 and 4, the front pivot plate 320 defines a tenth aperture, shown as front pivot plate second aperture 326, extending through the front pivot plate 320. The front pivot plate second aperture 326 is configured to align with a third frame aperture defined by the frame 12 to selectively receive a seventh fastener, shown as front pivot plate second fastener 328, to pivotably couple the front pivot plate 320 to the frame 12. By way of example, the front pivot plate 320 may pivot relative to the frame 12 about the front pivot plate second aperture 326 when the movable body 124 moves between the first position and the second position to move the second pushbar 170. When the movable body 124 moves toward the first position, the second pushbar 170 may cause the front pivot plate 320 to pivot about the front pivot plate second aperture 326 in the second opposing direction (e.g., a clockwise direction, etc.) and, when the movable body 124 moves toward the second position, the second pushbar 170 may cause the front pivot plate 320 to pivot about the front pivot plate second aperture 326 in the second opposing direction (e.g., a counter-clockwise direction, etc.).

As shown in FIGS. 3 and 4, the front pivot plate 320 defines a second plurality of apertures, shown as front pivot plate third apertures 330, extending through the front pivot plate 320. The front pivot plate third apertures 330 are each configured to pivotably couple the front pivot plate 320 to one of the front tie rods 340 (e.g., via fasteners, etc.). By way of example, a first of the front pivot plate third apertures 330 may be configured to pivotably couple the front pivot plate 320 to a first of the front tie rods 340 and a second of the front pivot plate third apertures 330 may be configured to pivotably couple the front pivot plate 320 to a second of the front tie rods 340. According to an exemplary embodiment, each of the front pivot plate third apertures 330 are equidistant from the front pivot plate second aperture 326. By way of example, a first of the front pivot plate third apertures 330 configured to pivotably couple the front pivot plate 320 to a first of the front tie rods 340 and a second of the front pivot plate third apertures 330 configured to pivotably couple the front pivot plate 320 to a second of the front tie rods 340 may be an equal distance from the front pivot plate second aperture 326. As a result, the front pivot plate third apertures 330 may each pivot a same distance (e.g., a same arced distance, etc.) around the front pivot plate second aperture 326 as the second pushbar 170 pivots the front pivot plate 320 about the front pivot plate second aperture 326 to allow for the front steering assembly 300 to pivot a first of the front tractive elements 62 corresponding to the first of the front tie rods 340 the same amount (e.g., a same angle, etc.) as a second of the front tractive elements 62 corresponding to the second of the front tie rods 340.

According to an exemplary embodiment, the front pivot plate 320 is the same as the rear pivot plate 220. For example, the front pivot plate 320 may define the first front pivot plate aperture 322, the front pivot plate second aperture 326, and the front pivot plate third apertures 330 in the same relative positions as the rear pivot plate 220 defines the rear pivot plate first apertures 222, the rear pivot plate second aperture 226, and the rear pivot plate third apertures 230 (e.g., a position of the first front pivot plate aperture 322 on the front pivot plate 320 may be the same as the rear pivot plate first apertures 222 on the rear pivot plate 220, a position of the front pivot plate second aperture 326 on the front pivot plate 320 may be the same as the rear pivot plate second aperture 226 on the rear pivot plate 220, a position of the front pivot plate third apertures 330 on the front pivot plate 320 may be the same as the rear pivot plate third apertures 230 on the rear pivot plate 220, etc.). As a result, the front pivot plate 320 and the rear pivot plate 220 may cause a first relationship between movement of the movable body 124 and steering of the rear tractive assembly 56 to be the same as a second relationship between movement of the movable body 124 and steering of the front tractive assembly 60. In other embodiments, the front pivot plate 320 is different from the rear pivot plate 220. For example, the front pivot plate 320 may define the first front pivot plate aperture 322, the front pivot plate second aperture 326, and the front pivot plate third apertures 330 in different relative positions that the rear pivot plate 220 defines the rear pivot plate first apertures 222, the rear pivot plate second aperture 226, and the rear pivot plate third apertures 230 (e.g., a position of the first front pivot plate aperture 322 on the front pivot plate 320 may be different from the rear pivot plate first apertures 222 on the rear pivot plate 220, a position of the front pivot plate second aperture 326 on the front pivot plate 320 may be different from the rear pivot plate second aperture 226 on the rear pivot plate 220, a position of the front pivot plate third apertures 330 on the front pivot plate 320 may be different from the rear pivot plate third apertures 230 on the rear pivot plate 220, etc.). As a result, the front pivot plate 320 and the rear pivot plate 220 may cause a first relationship between movement of the movable body 124 and steering of the rear tractive assembly 56 to be the different from a second relationship between movement of the movable body 124 and steering of the front tractive assembly 60.

As shown in FIGS. 3 and 4, first ends (e.g., inward ends, etc.) of the front tie rods 340, shown as front tie rod interior ends 342, define eleventh apertures, shown as front tie rod first apertures 344, extending through the front tie rod interior ends 342 of the front tie rods 340. The front tie rod first apertures 344 are each configured to selectively align with one of the front pivot plate third apertures 330 to receive an eighth fastener, shown as front pivot plate third fastener 332, to pivotably couple the front tie rods 340 to the front pivot plate 320. As shown in FIGS. 3 and 4, second ends (e.g., outward ends, etc.) of the front tie rods 340, shown as front tie rod exterior ends 346, define twelfth apertures, shown as front tie bar second apertures 348, extending through the front tie rod exterior ends 346 of the front tie rods 340. Each of the front tie bar second apertures 348 are configured to pivotably couple each of the front tie rods 340 to one of the front steering knuckles 350 (e.g., via fasteners, etc.).

As shown in FIGS. 3 and 4, each of the front steering knuckles 350 include a first portion, shown as front main body portions 352, coupled to one of the front tractive elements 62, and a second portion, shown as front arm portions 360, extending from the front main body portions 352. As shown in FIGS. 3 and 4, each of the front main body portions 352 defines a thirteenth aperture, shown as front main body apertures 354, extending through the front main body portions 352 of the front steering knuckles 350. The front main body apertures 354 are configured to align with fourth frame apertures defined by the frame 12 to selectively receive ninth fasteners, shown as front main body fasteners 356, to pivotably couple the front steering knuckles 350 to the frame 12. By way of example, the front steering knuckles 350 may pivot relative to the frame 12 about the front main body apertures 354 when the movable body 124 moves between the first position and the second position to move the second pushbar 170. When the movable body 124 moves toward the first position, the second pushbar 170 causes the front pivot plate 320 to pivot about the front pivot plate second aperture 326 in the first direction (e.g., clockwise, etc.), the pivoting of the front pivot plate 320 moves the front tie rods 340, and the movement of the front tie rods 340 causes the front steering knuckles 350, and thus the front tractive elements 62, to pivot about the front main body apertures 354 in the second opposing direction (e.g., counter-clockwise, etc.) such that the front steering knuckles 350 and the front tractive elements 62 are pivoted in an opposite direction from the front pivot plate 320. When the movable body 124 moves toward the second position, the second pushbar 170 causes the front pivot plate 320 to pivot about the front pivot plate second aperture 326 in the second opposing direction (e.g., counter-clockwise, etc.), the pivoting of the front pivot plate 320 moves the front tie rods 340, and the movement of the front tie rods 340 causes the front steering knuckles 350, and thus the front tractive elements 62, to pivot about the front main body apertures 354 in the first direction (e.g., clockwise, etc.) such that the front steering knuckles 350 and the front tractive elements 62 are pivoted in an opposite direction from the front pivot plate 320. In some embodiments, the suspension system 64 is coupled to the front steering knuckles 350.

As shown in FIGS. 3 and 4, the front arm portions 360 define fourteenth apertures, shown as front arm apertures 362, extending through the front arm portions 360 of the front steering knuckles 350. The front arm apertures 362 are each configured to align with one of the front tie bar second apertures 348 to selectively receive a tenth fastener, shown as front arm fasteners 364, to pivotably couple each of the front steering knuckles 350 to one of the front tie rods 340. By way of example, when the movable body 124 moves the second pushbar 170 to pivot the front pivot plate 320 about the front pivot plate second aperture 326, the resulting movement of the front tie rods 340 may pivot the front steering knuckles 350 about the front main body apertures 354 through the front arm fasteners 364.

According to an exemplary embodiment, the front pivot plate third apertures 330 defines a plurality of the first front pivot plate aperture 322 extending through the front pivot plate 320. The second pushbar aperture 174 may selectively align with any one of the first front pivot plate aperture 322 to receive the front pivot plate first fastener 324 to pivotably couple the second pushbar 170 to the front pivot plate 320. Each of the first front pivot plate aperture 322 may be spaced a different distance away from the front pivot plate second aperture 326. As a result of the first front pivot plate aperture 322 being spaced different distances away from the front pivot plate second aperture 326, the first front pivot plate aperture 322 may allow for the front steering assembly 300 to have different rear steering configurations that allow for different relationships between movement of the movable body 124 and pivoting of the front tractive elements 62 of the front tractive assembly 60. By way of example, when the second pushbar aperture 174 selectively aligns with a first of the first front pivot plate aperture 322 spaced a first distance from the front pivot plate second aperture 326, the movable body 124 moving a first amount may cause the front tractive elements 62 to pivot a first angle relative to the frame 12. However, when the second pushbar aperture 174 selectively aligns with a second of the first front pivot plate aperture 322 spaced a second distance from the front pivot plate second aperture 326 and the second distance is different than the first distance, the movable body 124 moving the first amount may cause the front tractive elements 62 to pivot a second angle relative to the frame 12 that is different than the first angle. Different relationships between the movement of the movable body 124 and the pivoting of the front tractive elements 62 of the front tractive assembly 60 may be desired by the operator of the vehicle 10 in order to adjust the performance of the vehicle 10 (e.g., decrease a turning radius of the front tractive assembly 60, increase a turning radius of the front tractive assembly 60, etc.).

In other embodiments, the front pivot plate 320 defines a plurality of the front pivot plate second aperture 326 configured to selectively align with the frame aperture of the frame 12 to receive the front pivot plate second fastener 328 to pivotably couple the front pivot plate 320 to the frame 12. Each of the front pivot plate second aperture 326 may be spaced a different distance from the first front pivot plate aperture 322. As a result, the front pivot plate second aperture 326 may allow for the front steering assembly 300 to be configured with different relationships between movement of the movable body 124 and pivoting of the front tractive elements 62 of the front tractive assembly 60. In still other embodiments, the front pivot plate 320 defines a first plurality of the front pivot plate third apertures 330 configured to selectively align with the front tie rod first apertures 344 of a first of the front tie rods 340 to receive the front pivot plate third fastener 332 to pivotably couple the first of the front tie rods 340 to the front pivot plate 320 and a second plurality of the front pivot plate third apertures 330 configured to selectively align with the front tie rod first apertures 344 of a second of front tie rods 340 to receive the front pivot plate third fastener 332 to pivotably couple the second of the front tie rods 340 to the front pivot plate 320. Each of the front pivot plate third apertures 330 of the first plurality of the front pivot plate third apertures 330 may be spaced a different distance from the front pivot plate second aperture 326 and each of the front pivot plate third apertures 330 of the second plurality of the front pivot plate third apertures 330 may be spaced a different distance from the front pivot plate second aperture 326. As a result, the first plurality of the front pivot plate third apertures 330 and the second plurality of the front pivot plate third apertures 330 may allow for the different relationships between movement of the movable body 124 and pivoting of the front tractive elements 62 of the front tractive assembly 60.

In some embodiments, the rear pivot plate 220 defines the plurality of the rear pivot plate first apertures 222 spaced different distances from the rear pivot plate second aperture 226 and the front pivot plate third apertures 330 defines the plurality of the first front pivot plate aperture 322 extending through the front pivot plate 320 spaced different distances from the front pivot plate second aperture 326. As a result, the rear pivot plate first apertures 222 and the first front pivot plate apertures 322 may allow for different relationships between (a) movement of the movable body 124 and pivoting of the rear tractive elements 58 of the rear tractive assembly 56 and (b) movement of the movable body 124 and pivoting of the front tractive elements 62 of the front tractive assembly 60. By way of example, when the first pushbar aperture 164 selectively aligns with a first of the rear pivot plate first apertures 222 spaced a first distance away from the rear pivot plate second aperture 226 and the second pushbar aperture 174 selectively aligns with a first of the first front pivot plate apertures 322 spaced the first distance away from the front pivot plate second aperture 326, the movable body 124 moving a first amount may simultaneously cause the rear tractive elements 58 to pivot a first angle in a first direction and the front tractive elements 62 to pivot the first angle in a second opposing direction. However, when the first pushbar aperture 164 selectively aligns with the first of the rear pivot plate first apertures 222 spaced the first distance away from the rear pivot plate second aperture 226, the second pushbar aperture 174 selectively aligns with a second of the first front pivot plate apertures 322 spaced a second distance away from the front pivot plate second aperture 326, and the second distance is different than the first distance, the movable body 124 moving a first amount may simultaneously cause the rear tractive elements 58 to pivot the first angle in a first direction and the front tractive elements 62 to pivot a second angle in a second opposing direction, the second angle different than the first angle. Different relationships between (a) the movement of the movable body 124 and the pivoting of the rear tractive elements 58 of the rear tractive assembly 56 and (b) the movement of the movable body 124 and the pivoting of the front tractive elements 62 of the front tractive assembly 60 may be desired by the operator of the vehicle 10 in order to adjust the performance of the vehicle 10 (e.g., decrease a turning radius of the vehicle 10, increase a turning radius of the vehicle 10, etc.).

In some embodiments, the front pivot plate 320 is configured as a modular pivot plate that can be replaced by another pivot plate. By way of example, while operating the vehicle 10, the relationships between the movement of the movable body 124 and the pivoting of the front tractive elements 62 of the front tractive assembly 60 may result in turning characteristics of the vehicle 10 that are undesirable (e.g., too sharp of turns, too gradual of turns, etc.). By configuring the front pivot plate 320 as a modular pivot plate, a first of the front pivot plates 320 with a first configuration (e.g., a first arrangement of the first front pivot plate aperture 322, the front pivot plate second aperture 326, and/or the front pivot plate third apertures 330, etc.) may be replaced with a second of the front pivot plates 320 with a second configuration (e.g., a second arrangement of the first front pivot plate aperture 322, the front pivot plate second aperture 326, and/or the front pivot plate third apertures 330, etc.) to change the turning characteristics of the vehicle 10.

According to an exemplary embodiment, the rear pivot plate first aperture 222 is positioned a first distance from the rear pivot plate second aperture 226 and the first front pivot plate aperture 322 is positioned a second distance from the front pivot plate second aperture 326, the second distance different from the first distance. As a result, the rear pivot plate first aperture 222 and the first front pivot plate aperture 322 may allow for different relationships between (a) movement of the movable body 124 and pivoting of the rear tractive elements 58 of the rear tractive assembly 56 and (b) movement of the movable body 124 and pivoting of the front tractive elements 62 of the front tractive assembly 60. By way of example, when the first pushbar aperture 164 selectively aligns with the rear pivot plate first apertures 222 spaced the first distance away from the rear pivot plate second aperture 226, the second pushbar aperture 174 selectively aligns with the first front pivot plate aperture 322 spaced the second distance away from the front pivot plate second aperture 326, and the first distance is different than the second distance, the movable body 124 moving a first amount may simultaneously cause the rear tractive elements 58 to pivot a first angle in a first direction and the front tractive elements 62 to pivot a second angle in a second opposing direction, the first angle different than the second angle. In some embodiments, relative positions of other features of the rear pivot plate 220 and the front pivot plate 320 (e.g., the rear pivot plate second aperture 226 and the front pivot plate second aperture 326, the rear pivot plate third apertures 230 and the front pivot plate third apertures 330, etc.) may be different to allow for different relationships between (a) the movement of the movable body 124 and the pivoting of the rear tractive elements 58 of the rear tractive assembly 56 and (b) the movement of the movable body 124 and the pivoting of the front tractive elements 62 of the front tractive assembly 60. Different relationships (e.g., turning characteristics, etc.) between (a) the movement of the movable body 124 and the pivoting of the rear tractive elements 58 of the rear tractive assembly 56 and (b) the movement of the movable body 124 and the pivoting of the front tractive elements 62 of the front tractive assembly 60 may allow for the vehicle 10 to complete a turn while minimizing lateral frictional forces on the front tractive elements 62 and/or the rear tractive elements 58.

### Left-Right Drive-by-Wire Steering System

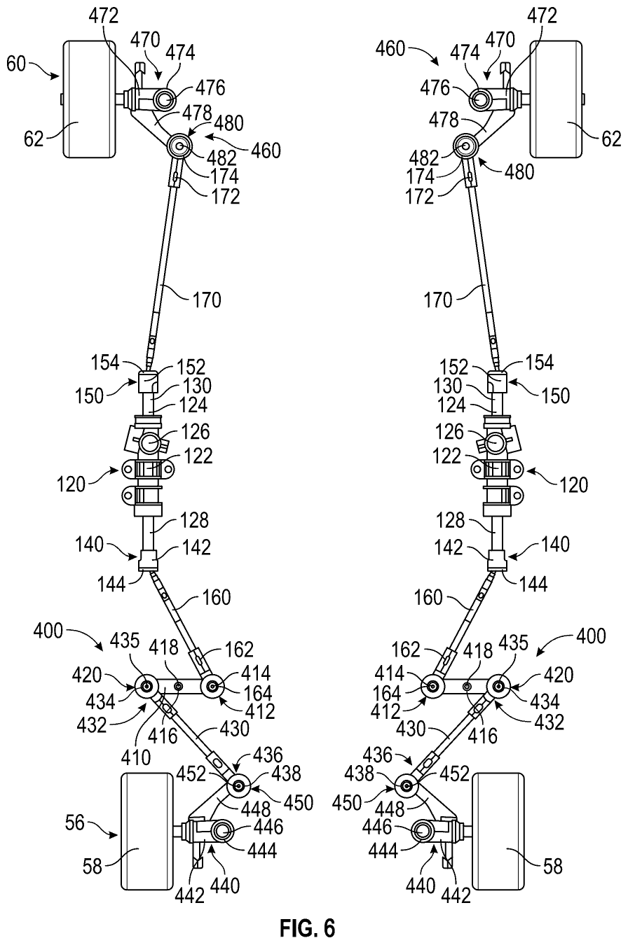

According to the exemplary embodiment shown in FIGS. 6-8, the steering system 110 (e.g., a left-right drive-by-wire steering system, a side drive-by-wire steering system, etc.) includes a plurality of the actuator assemblies 120 (e.g., two, one per side of the vehicle 10, etc.), a plurality of first steering assemblies, shown as rear steering assemblies 400, each coupled between one of the actuator assemblies 120 and one of the rear tractive elements 58 of the rear tractive assembly 56, and a plurality of second steering assemblies, shown as front steering assemblies 460, each coupled between one of the actuator assembly 120 and one of the front tractive elements 62 of the front tractive assembly 60. For example, the steering system 110 may include a first of the actuator assemblies 120, a first of the rear steering assemblies 400 coupled between the first of the actuator assemblies 120 and a first of the rear tractive elements 58 on a first side of the vehicle 10, a first of the front steering assemblies 460 coupled between the first of the actuator assembly 120 and a first of the front tractive elements 62 on the first side of the vehicle, a second of the actuator assemblies 120, a second of the rear steering assemblies 400 coupled between the second of the actuator assemblies 120 and a second of the rear tractive elements 58 on a second opposing side of the vehicle 10, and a second of the front steering assemblies 460 coupled between the second of the actuator assemblies 120 and a second of the front tractive elements 62 on the second side of the vehicle 10. The actuator assemblies 120 are configured to operate the rear steering assemblies 400 to steer the rear tractive assembly 56 and the front steering assemblies 460 to steer the front tractive assembly 60.

Each of the actuator assemblies 120 is configured to operate one of the rear steering assemblies 400 and one of the front steering assemblies 460 to simultaneously steer one of the rear tractive elements 58 of the rear tractive assembly 56 and one of the front tractive elements 62 of the front tractive assembly 60. By way of example, each of the actuator assemblies 120 may receive control signals from the vehicle control system 100 corresponding to steering of the rear tractive assembly 56 and the front tractive assembly 60 and may simultaneously operate one of the rear steering assemblies 400 to steer one of the rear tractive elements 58 and operate one of the front steering assemblies 460 to steer one of the front tractive elements 62. Each of the steer actuators 126 are configured to move the movable bodies 124 relative to the actuator housing 122 to simultaneously operate one of the rear steering assemblies 400 to steer one of the rear tractive elements 58 and operate one of the front steering assemblies 460 to steer one of the front tractive elements 62. By way of example, the steer actuators 126 may move the movable bodies 124 in a first direction to drive the rear steering assemblies 400 to steer the rear tractive elements 58 and to drive the front steering assemblies 460 to steer the front tractive elements 62. By way of another example, each of the movable bodies 124 may be slidably coupled to the actuator housings 122 and the steer actuators 126 may drive the movable bodies 124 to slide in a first direction relative to the actuator housings 122 and to slide in a second direction relative to the actuator housings 122 to operate the rear steering assemblies 400 to steer the rear tractive elements 58 and the front steering assemblies 460 to steer the front tractive elements 62. As a result of the multiple of the actuator assemblies 120 operating the rear steering assemblies 400 and the front steering assemblies 460, one of the actuator assemblies 120 may operate one of the rear steering assemblies 400 to steer one of the rear tractive elements 58 and one of the front steering assemblies 460 to steer one of the front tractive elements 62 separately from another of the actuator assemblies 120 operating another of the rear steering assemblies 400 to steer another of the rear tractive elements 58 and another of the front steering assemblies 460 to steer another of the front tractive elements 62.

When the movable bodies 124 are moved by the steer actuators 126 toward the first position, the movable bodies 124 may each operate one of the rear steering assemblies 400 to steer one of the rear tractive elements 58 towards a first direction (e.g., to the right, etc.) and the front steering assemblies 460 to steer one of the front tractive elements 62 towards a second direction (e.g., to the left, etc.), the second direction being opposite the first direction. As a result of each of the rear tractive elements 58 being steered toward the first direction and each of the front tractive elements 62 being steering toward the second direction, the vehicle 10 may turn toward the second direction when each of the movable bodies 124 are in the first position and the vehicle 10 is driving forward. When the movable bodies 124 are moved by the steer actuators 126 towards the second position, the movable bodies 124 may each operate one of the front steering assemblies 460 to steer one of the front tractive elements 62 towards the first direction and one of the rear steering assemblies 400 to steer one of the rear tractive elements 58 towards the second direction. As a result of each of the rear tractive elements 58 being steered toward the second direction and each of the front tractive elements 62 being steered toward the first direction, the vehicle 10 may turn toward the first direction when each of the movable bodies 124 are in the second position and the vehicle 10 is driving forward.

When a first of the movable bodies 124 is moved by a first of the steer actuators 126 towards the first position, the first of the movable bodies 124 may operate a first of the rear steering assemblies 400 to steer a first of the rear tractive elements 58 towards the first direction and a first of the front steering assemblies 460 to steer a first of the front tractive elements 62 towards the second direction. When a second of the movable bodies 124 is moved by a second of the steer actuators 126 towards the second position, the second of the movable bodies 124 may operate a second of the rear steering assemblies 400 to steer a second of the rear tractive elements 58 towards the second direction and a second of the front steering assemblies 460 to steer a second of the front tractive elements 62 towards the first direction. As a result of the first of the rear tractive elements 58 and the second of the front tractive elements 62 being steered towards the first direction and the second of the rear tractive elements 58 and the first of the front tractive elements 62 being steered towards the second direction, forward and/or rearward driving of the vehicle 10 may be inhibited when the first of the movable bodies 124 is in the first position and the second of the movable bodies 124 is in the second position.

When the movable bodies 124 are in the intermediate position, the rear steering assemblies 400 and the front steering assemblies 460 may steer the rear tractive elements 58 and the front tractive elements 62 in a same direction (e.g., straight forward, straight ahead, etc.). When the movable bodies 124 are moved by the steer actuators 126 from the intermediate position toward the first position, the rear steering assemblies 400 may steer the rear tractive elements 58 in the first direction and the front steering assemblies 460 may steer the front tractive elements 62 in the second direction. When the movable bodies are moved by the steer actuators from the intermediate position towards the second position, the rear steering assemblies 400 may steer the rear tractive elements 58 in the second direction and the front steering assemblies 460 may steer the front tractive elements 62 in the first direction.

As shown in FIGS. 6-8, each of the rear steering assemblies 400 includes a first plate, shown as rear pivot plate 410, pivotably coupled to the frame 12 and pivotably coupled to the first pushbar 160 (e.g., a rear pushbar, etc.) of one of the actuator assemblies 120, a first tie rod, shown as rear tie rod 430, pivotably coupled to the rear pivot plate 410, and a first steering body, shown as rear steering knuckle 440, (a) coupled to one of the rear tractive elements 58, (b) pivotably coupled to the rear steering knuckle 440, and (c) pivotably coupled to the frame 12. The movement of the movable bodies 124 drive the rear steering assemblies 400 to each pivot one of the rear tractive elements 58 relative to the frame 12 to steer the one of the rear tractive elements 58. By way of example, when one of the actuator assemblies 120 moves the movable body 124 of the one of the actuator assemblies 120 rearwards towards the second position, the movable body 124 may move the first ball joint 140 and the first pushbar 160 of the one of the actuator assemblies 120 rearward. The movement of the first pushbar 160 causes the rear pivot plate 410 pivotably coupled to the first pushbar 160 to pivot relative frame 12 in a first rotational direction, which pushes the rear tie rod 430. The movement of the rear tie rod 430 causes the rear steering knuckle 440 to pivot one of the rear tractive elements 58 relative to the frame 12 in a second rotational direction to steer the one of the rear tractive elements 58, the second rotational direction opposite the first rotational direction.

As shown in FIGS. 6-8, the first pushbar apertures 164 are configured to pivotably couple each of the first pushbars 160 to one of the rear pivot plates 410 (e.g., via a fastener, the rear pivot plate 410 of one of the rear steering assemblies 400, etc.). As shown in FIGS. 6-8, each of the rear pivot plates 410 defines a third aperture, shown as rear pivot plate first aperture 412, extending through the rear pivot plates 410. Each of the rear pivot plate first apertures 412 is configured to align with the first pushbar aperture 164 of one of the first pushbars 160 to selectively receive a first fastener (e.g., a bolt, a pin, an anchor, etc.), shown as rear pivot plate first fasteners 414, to pivotably couple each of the first pushbars 160 to one of the rear pivot plates 410.

As shown in FIGS. 6-8, each of the rear pivot plates 410 defines a fourth aperture, shown as rear pivot plate second aperture 416, extending through the rear pivot plates 410. The rear pivot plate second aperture 416 are each configured to align with a first frame aperture defined by the frame 12 to selectively receive a second fastener, shown as rear pivot plate second fasteners 418, to pivotably coupled the rear pivot plates 410 to the frame 12. By way of example, each of the rear pivot plates 410 may pivot relative to the frame 12 about the rear pivot plate second apertures 416 when the movable bodies 124 move between the first position and the second position to move the first pushbars 160. When the movable bodies 124 move towards the first position, the first pushbars 160 may cause the rear pivot plates 410 to pivot about the rear pivot plate second apertures 416 in a first direction (e.g., a counter-clockwise direction, etc.) and, when the movable bodies 124 move toward the second position, the first pushbars 160 may cause the rear pivot plates 410 to pivot about the rear pivot plate second apertures 416 in a second opposing direction (e.g., a clockwise direction, etc.).

As shown in FIGS. 6-8, each of the rear pivot plates 410 defines a fifth aperture, shown as rear pivot plate third aperture 420, extending through the rear pivot plates 410. The rear pivot plate third apertures 420 are configured to pivotably couple each the rear pivot plates 410 to one of the rear tie rods 430 (e.g., via fasteners, etc.).

As shown in FIGS. 6-8, first ends (e.g., forward ends, etc.) of each of the rear tie rods 430, shown as rear tie rod forward ends 432, defines a sixth aperture, shown as rear tie rod first aperture 434, extending through the rear tie rod forward ends 432 of the rear tie rods 430. The rear tie rod first apertures 434 are each configured to align with the rear pivot plate third aperture 420 of one of the rear pivot plates 410 to receive a third fastener, shown as rear pivot plate third fastener 435, to pivotably coupled each of the rear tie rods 430 to one of the rear pivot plates 410. As shown in FIGS. 6-8, second ends (e.g., rearward ends, etc.) of each of the rear tie rods 430, shown as rear tie rod rearward ends 436, defines a seventh aperture, shown as rear tie rod second apertures 438, extending through the rear tie rod rearward ends 436 of the rear tie rod 430. Each of the rear tie rod second apertures 438 is configured to pivotably couple one of the rear tie rods 430 to one of the rear steering knuckles 440 (e.g., via fasteners, etc.).

As shown in FIGS. 6-8, each of the rear steering knuckles 440 include a first portion, shown as rear main body portion 442, coupled to one of the rear tractive elements, and a second portion, shown as rear arm portion 448, extending from the rear main body portion 442. Each of the rear main body portions 442 defines an eighth aperture, shown as rear main body aperture 444, extending through the rear main body portion 442 of the rear steering knuckle 440. The rear main body apertures 444 are configured to align with second frame apertures defined by the frame 12 to selectively receive fourth fasteners, shown as rear main body fasteners 446, to pivotably couple the rear steering knuckle 440 to the frame 12. By way of example, the rear steering knuckle 440 may pivot relative to the frame 12 about the rear main body apertures 444 when the movable bodies 124 move between the first position and the second position to move the first pushbars 160. When the movable bodies 124 move towards the first position, the first pushbars 160 cause the rear pivot plates 410 to pivot about the rear pivot plate second apertures 416 in the first direction (e.g., counter-clockwise, etc.), the pivoting of the rear pivot plates 410 moves the rear tie rods 430, and the movement of the rear tie rods 430 causes the rear steering knuckles 440, and thus the rear tractive elements 58, to pivot about the rear main body apertures 444 in the second opposing direction (e.g., clockwise, etc.) such that the rear steering knuckles 440 and the rear tractive elements 58 are pivoted in an opposite direction from the rear pivot plates 410. When the movable bodies 124 move towards the second position, the first pushbars 160 cause the rear pivot plates 410 to pivot about the rear pivot plate second apertures 416 in the second opposing direction (e.g., clockwise, etc.), the pivoting of the rear pivot plates 410 moves the rear tie rods 430, and the movement of the rear tie rods 430 causes the rear steering knuckles 440, and thus the rear tractive elements 58, to pivot about the rear main body apertures 444 in the first direction (e.g., counter-clockwise, etc.) such that the rear steering knuckles 440 and the rear tractive elements 58 are pivoted in an opposite direction from the rear pivot plates 410. In some embodiments, the suspension system 64 is coupled to the rear steering knuckles 440.

As shown in FIGS. 6-8, the rear arm portions 448 define ninth apertures, shown as rear arm apertures 450, extending through the rear arm portions 448 of the rear steering knuckles 440. The rear arm apertures 450 are each configured to align with the rear tie rod second aperture 438 of one of the rear tie rods 430 to selectively receive a fifth fastener, shown as rear arm fastener 452, to pivotably couple each of the rear steering knuckles 440 to one of the rear tie rods 430. By way of example, when the movable bodies 124 move the first pushbars 160 to pivot the rear pivot plates 410 about the rear pivot plate second apertures 416, the resulting movement of the rear tie rods 430 may pivot the rear steering knuckles 440 about the rear main body apertures 444 through the rear arm fasteners 452.

In some embodiments, the rear pivot plates 410 are configured as modular pivot plates that can be replaced by another pivot plate. By way of example, while operating the vehicle 10, the relationships between the movements of the movable bodies 124 and the pivoting of the rear tractive elements 58 may result in turning characteristics of the vehicle 10 that are undesirable (e.g., too sharp of turns, too gradual of turns, etc.). By configuring the rear pivot plates 410 as modular pivot plates, first of the rear pivot plates 410 with a first configuration (e.g., a first arrangement of the rear pivot plate first aperture 412, the rear pivot plate second aperture 416, and/or the rear pivot plate third aperture 420, etc.) may be replaced with second of the rear pivot plates 410 with a second configuration (e.g., a second arrangement of the rear pivot plate first aperture 412, the rear pivot plate second aperture 416, and/or the rear pivot plate third aperture 420, etc.) to change the turning characteristics of the vehicle 10.

As shown in FIGS. 6-8, each of the front steering assemblies 460 includes a second steering body, shown as front steering knuckle 470, (a) coupled to one of the front tractive elements 62, (b) pivotably coupled to one of the second pushbars 170, and (c) pivotably coupled to the frame 12. The movement of the movable bodies 124 drive each of the front steering assemblies 460 to pivot one of the front tractive elements 62 relative to the frame 12 to steer the one of the front tractive elements 62. By way of example, when one of the actuator assemblies 120 moves the movable body 124 of the one of the actuator assemblies 120 rearwards towards the second position, the movable body 124 may move the second ball joint 150 and the second pushbar 170 of the one of the actuator assemblies 120 rearward. The movement of the second pushbar 170 causes the front steering knuckle 470 pivotably coupled to the second pushbar 170 to pivot one of the front tractive elements 62 relative to the frame 12 in a rotational direction to steer the one of the front tractive elements 62. As shown in FIGS. 6-8, the second pushbar apertures 174 are configured to pivotably couple each of the second pushbars 170 to one of the front steering knuckles 470 (e.g., via a fastener, the front steering knuckle 470 of one of the front steering assemblies 460, etc.).

As shown in FIGS. 6-8, each of the front steering knuckles 470 include a first portion, shown as front main body portion 472, coupled to one of the front tractive elements 62, and a second portion, shown as front arm portion 478, extending from the front main body portion 472. As shown in FIGS. 6-8, each of the front main body portions 472 defines a tenth aperture, shown as front main body apertures 474, extending through the front main body portion 472 of the front steering knuckles 470. The front main body apertures 474 are configured to align with third frame apertures defined by the frame 12 to selectively receive fifth fasteners, shown as front main body fasteners 476, to pivotably couple the front steering knuckles 470 to the frame 12. By way of example, the front steering knuckles 470 may pivot relative to the frame 12 about the front main body apertures 474 when the movable bodies 124 move between the first position and the second position to move the second pushbars 170. When the movable bodies 124 move toward the first position, the second pushbars 170 cause the front steering knuckles 470, and thus the front tractive elements 62, to pivot about the front main body apertures 474 in a first direction (e.g., counter-clockwise, etc.). When the movable bodies 124 move toward the second position, the second pushbars 170 cause the front steering knuckles 470, and thus the front tractive elements, to pivot about the front main body apertures 474 in a second opposing direction (e.g., clockwise, etc.). In some embodiments, the suspension system 64 is coupled to the front steering knuckles 470.

As shown in FIGS. 6-8, the front arm portions 478 define eleventh apertures, shown as front arm apertures 480, extending through the front arm portions 478 of the front steering knuckles 470. The front arm apertures 480 are each configured to align with the second pushbar aperture 174 of one of the second pushbars 170 to selectively receive a sixth fastener, shown as front arm fastener 482, to pivotably couple each of the front steering knuckles 470 to one of the second pushbars 170. By way of example, when the movable bodies 124 move the second pushbars 170, the movement of the second pushbars 170 may pivot the front steering knuckles 470 about the front arm apertures 480 through the front arm fasteners 482.

In some embodiments, the vehicle control system 100 is configured to control the actuator assemblies 120 differently such that (a) the front tractive element 62 and the rear tractive element 58 on a first side (e.g., a left side, a driver's side, etc.) of the vehicle 10 are steered a different amount than (b) the front tractive element 62 and the rear tractive element 58 on an opposing second side (e.g., a right side, a passenger's side, etc.) of the vehicle 10. By way of example, the “inner” tractive elements may be turned more than the “outer” tractive elements. For example, when making a right turn, the tractive elements on the right side of the vehicle 10 (i.e., the inner tractive elements) may be turned more than the tractive elements on the left side of the vehicle 10 (i.e., the outer tractive elements) such that the right, inner tractive elements follow a first circular path having a first radius and the left, outer tractive elements follow a second circular path having a second radius that is greater than the first radius. As another example, when making a left turn, the tractive elements on the left side of the vehicle 10 (i.e., the inner tractive elements) may be turned more than the tractive elements on the right side of the vehicle 10 (i.e., the outer tractive elements) such that the left, inner tractive elements follow the first circular path having the first radius and the right, outer tractive elements follow the second circular path having the second radius that is greater than the first radius. Accordingly, the inner tractive elements may be turned more to follow a tighter or smaller circular path whereas the outer tractive elements may be turned to follow a looser or larger circular path. Such variable inner/outer steering control may improve steering performance of the vehicle 10 and prevent tearing up or destroying the surface (e.g., turf, fairway, etc.) that the vehicle 10 is driving on.

### Forward-Rearward Drive-by-Wire Steering System

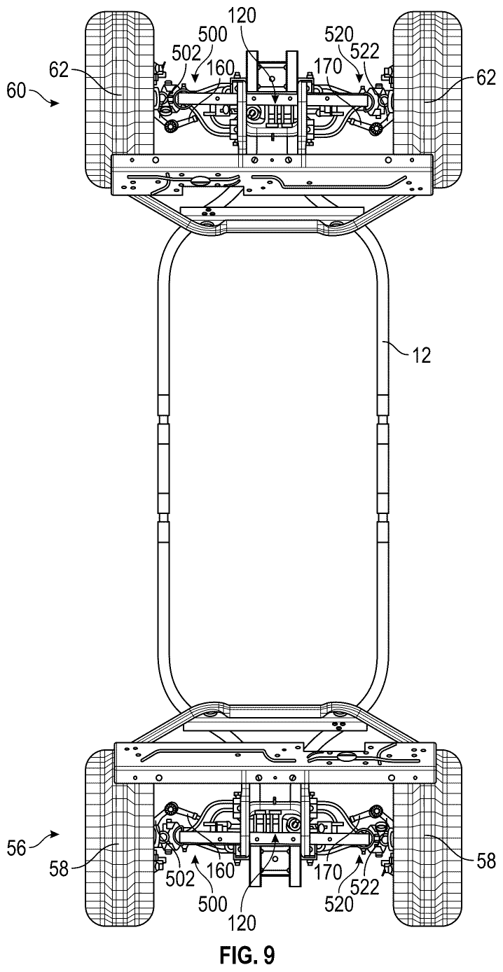

According to the exemplary embodiment shown in FIGS. 9-11, the steering system 110 (e.g., a forward-rearward drive-by-wire steering system, etc.) includes a plurality of the actuator assemblies 120 (e.g., two, a forward of the actuator assemblies 120 and a rearward of the actuator assemblies 120, etc.), a plurality of first steering assemblies, shown as left side steering assemblies 500, each coupled between one of the actuator assemblies 120 and one of the rear tractive elements 58 or one of the front tractive elements 62, and a plurality of second steering assemblies, shown as right side steering assemblies 520, each coupled between one of the actuator assemblies 120 and one of the rear tractive elements 58 or one of the front tractive elements 62. For example, the steering system 110 may include a first of the actuator assemblies 120, a first of the left side steering assemblies 500 coupled between the first of the actuator assemblies 120 and a first of the rear tractive elements 58 on a first side of the vehicle 10, a first of the right side steering assemblies 520 coupled between the first of the actuator assemblies 120 and a second of the rear tractive elements 58 on a second opposing side of the vehicle 10, a second of the actuator assemblies 120, a second of the left side steering assemblies 500 coupled between the second of the actuator assemblies 120 and a first of the front tractive elements 62 on the first side of the vehicle 10, and a second of the right side steering assemblies 520 coupled between the second of the actuator assemblies 120 and a second of the front tractive elements on the second opposing side of the vehicle 10. The actuator assemblies 120 are configured to operate the left side steering assemblies 500 to steer the rear tractive elements 58 and the front tractive elements 62 on a first side (e.g., a left side, etc.) of the vehicle 10 and the right side steering assemblies 520 to steer the rear tractive elements 58 and the front tractive elements 62 on a second opposing side (e.g., a right side, etc.) of the vehicle 10.

Each of the actuator assemblies 120 is configured to operate one of the left side steering assemblies 500 and one of the right side steering assemblies 520 to simultaneously steer one of (a) the rear tractive elements 58 of the rear tractive assembly 56 or (b) the front tractive elements 62 of the front tractive assembly 60. By way of example, one of the actuator assemblies 120 may receive control signals from the vehicle control system 100 corresponding to steering the rear tractive assembly 56 and may simultaneously operate one of the left side steering assemblies 500 and one of the right side steering assemblies 520 to steer the rear tractive assembly 56. By way of another example, one of the actuator assemblies 120 may receive control signals from the vehicle control system 100 corresponding to steering the front tractive assembly 60 and may simultaneously operate one of the left side steering assemblies 500 and one of the right side steering assemblies 520 to steer the front tractive assembly 60. Each of the steer actuators 126 are configured to move the movable bodies 124 relative to the actuator housing 122 to simultaneously operate one of the left side steering assemblies 500 and one of the right side steering assemblies 520 to steer one of the rear tractive assembly 56 or the front tractive assembly 60. By way of example, the steer actuators 126 may move the movable bodies 124 in a first direction to drive the left side steering assemblies 500 and the right side steering assemblies 520 to steer the rear tractive elements 58 or to drive the front tractive elements 62. By way of another example, each of the movable bodies 124 may be slidably coupled to the actuator housings 122 and the steer actuators 126 may drive the movable bodies 124 to slide in a first direction relative to the actuator housings 122 and to slide in a second direction relative to the actuator housings 122 to operate the left side steering assemblies 500 and the right side steering assemblies 520 to steer the rear tractive assembly 56 or the front tractive assembly 60. As a result of the multiple of the actuator assemblies 120 operating the left side steering assemblies 500 and the right side steering assemblies 520, one of the actuator assemblies 120 may operate one of the left side steering assemblies 500 and one of the right side steering assemblies 520 to steer the rear tractive assembly 56 separately from another of the actuator assemblies 120 operating another of the left side steering assemblies 500 and another of the right side steering assemblies 520 to steer the front tractive assembly 60.

When a forward of the movable bodies 124 (e.g., a first of the movable bodies 124, etc.) is moved by a forward of the steer actuators 126 towards the first position and a rearward of the movable bodies 124 (e.g., a second of the movable bodies 124, etc.) is moved by a rearward of the steer actuators 126 towards the first position, the forward of the movable bodies 124 may operate a forward of the left side steering assemblies 500 and a forward of the right side steering assemblies 520 to steer the front tractive assembly 60 towards a first direction (e.g., to the right) and the rearward of the movable bodies 124 may operate a rearward of the left side steering assemblies 500 and a rearward of the right side steering assemblies 520 to steer the rear tractive assembly 56 towards a second direction (e.g., to the left, etc.), the second direction being opposite the first. As a result of the front tractive assembly 60 being steered towards the first direction and the rear tractive assembly 56 being steered towards the second direction, the vehicle 10 may turn towards the first direction when the forward of the forward of the movable bodies 124 is in the first position, the rearward of the movable bodies 124 is in the first position, and the vehicle 10 is driving forward. When the forward of the movable bodies 124 is moved by the forward of the steer actuators 126 towards the second position and the rearward of the movable bodies 124 is moved by the rearward of the steer actuators 126 towards the second position, the forward of the movable bodies 124 may operate the forward of the left side steering assemblies 500 and the forward of the right side steering assemblies 520 to steer the front tractive assembly 60 towards the second direction and the rearward of the movable bodies 124 may operate the rearward of the left side steering assemblies 500 and the rearward of the right side steering assemblies 520 to steer the rear tractive assembly 56 towards the first direction. As a result of the front tractive assembly 60 being steered towards the second direction and the rear tractive assembly 56 being steered towards the first direction, the vehicle 10 may turn towards the second direction when the forward of the forward of the movable bodies 124 is in the second position, the rearward of the movable bodies 124 is in the second position, and the vehicle 10 is driving forward.

When the forward of the movable bodies 124 is moved by the forward of the steer actuators 126 towards the first position and the rearward of the movable bodies 124 is moved by the rearward of the steer actuators 126 towards the second position, the forward of the movable bodies 124 may operate the forward of the left side steering assemblies 500 and the forward of the right side steering assemblies 520 to steer the front tractive assembly 60 towards the first direction and the rearward of the movable bodies 124 may operate the rearward of the left side steering assemblies 500 and the rearward of the right side steering assemblies 520 to steer the rear tractive assembly 56 towards the first direction. As a result of both the front tractive assembly 60 being steered towards the first direction and the rear tractive assembly 56 being steered towards the first direction, the vehicle 10 may drive towards the first direction (e.g., crab walk, drive in a straight line, drive towards the first direction without turning, etc.) when the forward of the forward of the movable bodies 124 is in the first position, the rearward of the movable bodies 124 is in the second position, and the vehicle 10 is driving forward. Similarly, the vehicle 10 may drive towards the second direction (e.g., drive towards the second direction without turning, etc.) when the forward of the forward of the movable bodies 124 is in the second position, the rearward of the movable bodies 124 is in the first position, and the vehicle 10 is driving forward.

When the movable bodies 124 are in the intermediate position, the left side steering assemblies 500 and the right side steering assemblies 520 may steer the rear tractive elements 58 and the front tractive elements 62 in a same direction (e.g., straight forward, straight ahead, etc.). When the movable bodies 124 are moved by the steer actuators 126 from the intermediate position toward the first position, the forward of the left side steering assemblies 500 and the forward of the right side steering assemblies 520 may steer the front tractive assembly 60 in the first direction and the rearward of the left side steering assemblies 500 and the rearward of the right side steering assemblies 520 may steer the rear tractive assembly 56 in the second direction. When the movable bodies 124 are moved by the steer actuators 126 from the intermediate position toward the second position, the forward of the left side steering assemblies 500 and the forward of the right side steering assemblies 520 may steer the front tractive assembly 60 in the second direction and the rearward of the left side steering assemblies 500 and the rearward of the right side steering assemblies 520 may steer the rear tractive assembly 56 in the first direction.

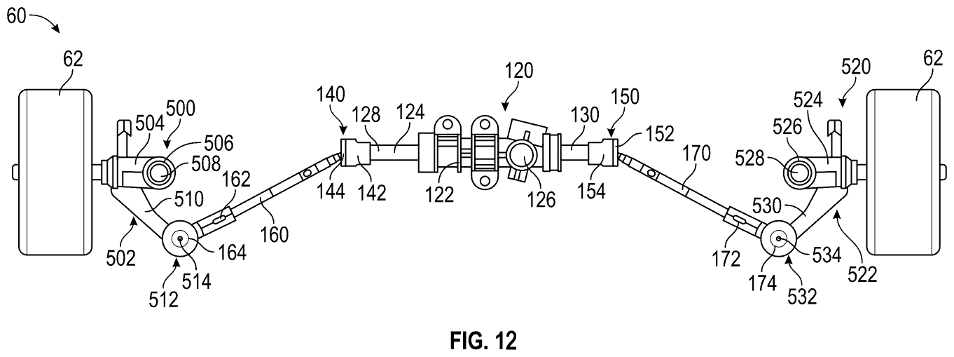

As shown in FIGS. 9-12, each of the left side steering assemblies 500 includes a first steering body, shown as left side steering knuckle 502, (a) coupled to one of the front tractive elements 62 or one of the rear tractive elements 58, (b) pivotably coupled to one of the first pushbars 160, and (c) pivotably coupled to the frame 12. The movement of the movable bodies 124 drive each of the left side steering assemblies 500 to pivot one of the front tractive elements 62 or one of the rear tractive elements 58 on a left side of the vehicle 10. By way of example, when a forward of the actuator assemblies 120 moves the movable body 124 of the forward of the actuator assemblies 120 towards the first position, the movable body 124 may move the first ball joint 140 and the first pushbar 160 of the forward of the actuator assemblies 120 leftward. The movement of the first pushbar 160 causes the left side steering knuckle 502 pivotably coupled to the first pushbar 160 to pivot a leftward of the front tractive elements 62 relative to the frame 12 in a rotational direction to steer the one of the front tractive elements 62. As shown in FIG. 12, the first pushbar apertures 164 are configured to pivotably couple each of the first pushbars 160 to one of the left side steering knuckles 502 (e.g., via a fastener, etc.).

As shown in FIG. 12, each of the left side steering knuckles 502 include a first portion, shown as left main body portions 504, coupled to one of the front tractive element 62 or the rear tractive element 58 on the left side of the vehicle 10, and a second portion, shown as left arm portions 510, extending from the left main body portions 504. As shown in FIG. 12, each of the left main body portions 504 defines a third aperture, shown as left main body aperture 506, extending through the left main body portion 504 of the left side steering knuckle 502. The main body apertures 506 are configured to align with first frame apertures defined by the frame 12 to selectively receive first fasteners, shown as left main body fasteners 508, to pivotably couple the right side steering knuckles 522 to the frame 12. By way of example, the left side steering knuckles 502 may pivot relative to the frame 12 about the main body apertures 506 when the movable bodies 124 move between the first position and the second position to move the first pushbars 160. When the movable bodies 124 move toward the first position, the first pushbars 160 cause a forward of the left side steering knuckles 502, and thus the front tractive element 62 on the left side of the vehicle 10, to pivot about the main body aperture 506 of the forward of the left side steering knuckles 502 in a first direction (e.g., clockwise, etc.) and a rearward of the left side steering knuckles 502, and thus the rear tractive element 58 on the left side of the vehicle 10, to pivot about the main body aperture 506 of the rearward of the left side steering knuckles 502 in a second direction (e.g., counter-clockwise, etc.), the second direction opposite the first direction. When the movable bodies 124 move toward the second position, the first pushbars 160 cause a forward of the left side steering knuckles 502, and thus the front tractive element 62 on the left side of the vehicle 10, to pivot about the main body aperture 506 of the forward of the left side steering knuckles 502 in the second direction and a rearward of the left side steering knuckles 502, and thus the rear tractive element 58 on the left side of the vehicle 10, to pivot about the main body aperture 506 of the rearward of the left side steering knuckles 502 in the first direction. In some embodiments, the suspension system 64 is coupled to the left side steering knuckles 502.

As shown in FIG. 12, the left arm portions 510 define fourth apertures, shown as left arm apertures 512, extending through the left arm portions 510 of the left side steering knuckles 502. The left arm apertures 512 are each configured to align with the first pushbar aperture 164 of one of the first pushbars 160 to selectively receive a second fastener, shown as left arm fastener 514, to pivotable couple each of the left side steering knuckles 502 to one of the first pushbars 160. By way of example, when the movable bodies 124 move the first pushbars 160, the movement of the first pushbars 160 may pivot the left side steering knuckles 502 about the left arm apertures 512 through the left arm fasteners 514.

As shown in FIGS. 9-12, each of the right side steering assemblies 520 includes a second steering body, shown as right side steering knuckle 522, (a) coupled to one of the front tractive elements 62 or one of the rear tractive elements 58, (b) pivotably coupled to one of the second pushbars 170 and (c) pivotably coupled to the frame 12. The movement of the movable bodies 124 drive each of the right side steering assemblies 520 to pivot one of the front tractive elements 62 or one of the rear tractive elements 58 on a right side of the vehicle 10. By way of example, when a forward of the actuator assemblies 120 moves the movable body 124 of the forward of the actuator assemblies 120 towards the first position, the movable body 124 may move the second ball joint 150 and the second pushbar 170 of the forward of the actuator assemblies 120 leftward. The movement of the second pushbar 170 causes the right side steering knuckle 522 pivotably coupled to the second pushbar 170 to pivot a rightward of the front tractive elements 62 relative to the frame 12 in a rotational direction to steer the one of the front tractive elements 62. As shown in FIG. 12, the second pushbar apertures 174 are configured to pivotably couple each of the second pushbars 170 to one of the right side steering knuckles 522 (e.g., via a fastener, etc.).

As shown in FIG. 12, each of the right side steering knuckles 522 includes a first portion, shown as right main body portion 524, coupled to one of the front tractive element 62 or the rear tractive element 58 on the right side of the vehicle 10, and a second portion, shown as right arm portion 530, extending from the right main body portion 524. As shown in FIG. 12, each of the right main body portions 524 defines a fifth aperture, shown as right main body aperture 526, extending through the right main body portions 524 of the right side steering knuckle 522. The right main body apertures 526 are configured to align with second frame apertures defined by the frame 12 to selectively receive third fasteners, shown as right main body fasteners 528, to pivotably couple the right side steering knuckles 522 to the frame 12. By way of example, the right side steering knuckles 522 may pivot relative to the frame 12 about the right main body apertures 526 when the movable bodies 124 move between the first position and the second position to move the second pushbars 170. When the movable bodies 124 move toward the first position, the second pushbars 170 cause a forward of the right side steering knuckles 522, and thus the front tractive element 62 on the left right of the vehicle 10, to pivot about the right main body apertures 526 of the forward of the right side steering knuckles 522 in the first direction (e.g., clockwise, etc.) and a rearward of the right side steering knuckles 522, and thus the rear tractive element 58 on the right side of the vehicle 10, to pivot about the right main body apertures 526 of the rearward of the right side steering knuckles 522 in the second direction (e.g., counter-clockwise, etc.). When the movable bodies 124 move toward the second position, the second pushbars 170 cause a forward of the right side steering knuckles 522, and thus the front tractive element 62 on the right side of the vehicle 10, to pivot about the right main body apertures 526 of the forward of the right side steering knuckles 522 in the second direction and a rearward of the right side steering knuckles 522, and thus the rear tractive element 58 on the right side of the vehicle 10, to pivot about the right main body apertures 526 of the rearward of the left side steering knuckles 502 in the first direction. In some embodiments, the suspension system 64 is coupled to the right side steering knuckles 522.

As shown in FIG. 12, the right arm portions 530 define sixth apertures, shown as right arm apertures 532, extending through the right arm portions 530 of the right side steering knuckles 522. The right arm apertures 532 are each configured to align with the second pushbar aperture 174 of one of the second pushbars 170 to selectively receive a fourth fastener, shown as right arm fastener 534, to pivotable couple each of the right side steering knuckles 522 to one of the second pushbars 170. By way of example, when the movable bodies 124 move the second pushbars 170, the movement of the second pushbars 170 may pivot the right side steering knuckles 522 about the right arm apertures 532 through the right arm fasteners 534.

According to the exemplary embodiment shown in FIGS. 9-11, the forward and rearward drive-by-wire steering arrangement of the steering system 100 facilitates manufacturing the frame 12 having symmetry about a central lateral axis thereof. Accordingly, the frame 12 can have less complexity and more common components making manufacturing more efficient and cost-effective.

In some embodiments, the vehicle control system 100 is configured to control the actuator assemblies 120 based on a tire size of the front tractive elements 62 and the rear tractive elements 58. For example, when larger tires are installed onto the front tractive elements 62 and the rear tractive elements 58, the larger tires may rub on the frame 12 during turning maneuvers. Accordingly, the vehicle 10 could be put into a “large tire” mode or a “tire size selection” mode where the vehicle control system 100 could compensate for such larger tires. By way of example, the vehicle control system 100 may provide various tire size options for the operator to select from. By way of another example, the operator may be able to provide a custom size selection to the vehicle control system 100. The vehicle control system 100 may then be configured to variably limit the amount that the front tractive elements 62 and the rear tractive elements 58 can be turned to prevent rubbing on the frame 12. In some embodiments, the vehicle control system 100 is configured to only provide steering with the front tractive elements 62 or provide more steering with the front tractive elements 62 than the rear tractive elements 58 up until the point at which the front tractive elements 62 are about to rub on the frame 12. At this point, the vehicle control system 100 may be configured to start turning with the rear tractive elements 58 or increase turning with the rear tractive elements 58 to compensate of the reduced turning of the front tractive elements 62.

### Fleet Monitoring and Control System

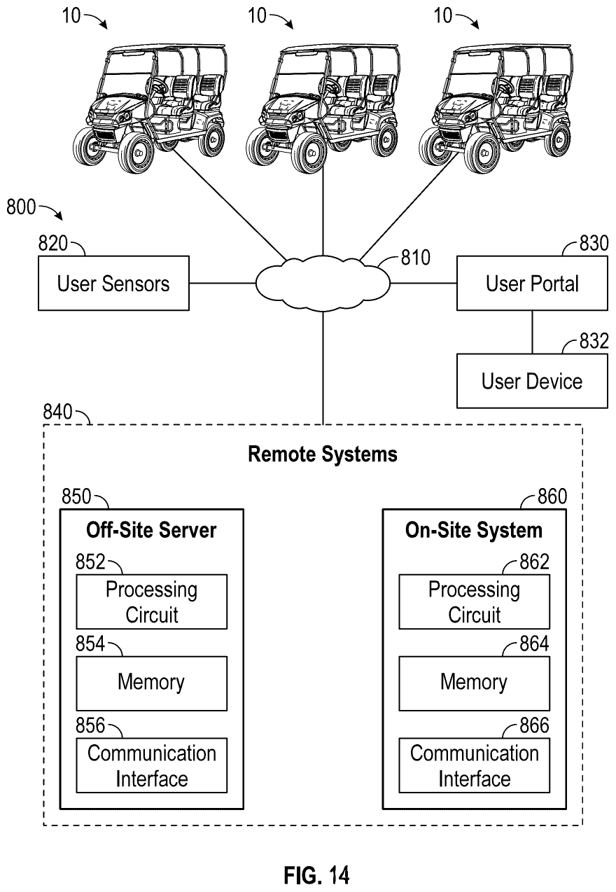

As shown in FIG. 14, a site monitoring and control system, shown as fleet monitoring and control system 800, includes one or more vehicles 10; one or more second sensors, shown as user sensors 820, positioned remote or separate from the vehicles 10; an operator interface, shown as user portal 830, positioned remote or separate from the vehicles 10; an external or remote user device, shown as user device 832, positioned remote or separate from the vehicles 10; and one or more external processing systems, shown as remote systems 840, positioned remote or separate from the vehicles 10. The vehicles 10, the user sensors 820, the user portal 830, and the remote systems 840 communicate via one or more communications protocols (e.g., Bluetooth, Wi-Fi, cellular, radio, through the Internet, etc.) through a network, shown as communications network 810. In some embodiments, the fleet monitoring and control system 800 does not includes the user portal 830 and/or the user device 832.

The user sensors 820 may be or include one or more sensors that are carried by or worn by an operator of one of the vehicles 10. By way of example, the user sensors 820 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 820 may communicate directly with the vehicles 10, directly with the remote systems 840, and/or indirectly with the remote systems 840 (e.g., through the vehicles 10 as an intermediary).

The user portal 830 may be configured to facilitate operator access to dashboards including the vehicle data, the operator data, information available at the remote systems 840, etc. to manage and operate the site (e.g., golf course) such as for advanced scheduling purposes, to identify persons breaking course guidelines or rules, to monitor locations of the vehicles 10, etc. The user portal 830 may also be configured to facilitate operator implementation of configurations and/or parameters for the vehicles 10 and/or the site (e.g., setting speed limits, setting geofences, etc.). As shown in FIG. 4, the user portal 830 is accessible via the user device 832. The user device 832 may be or include a computer, laptop, smartphone, tablet, or the like. The user portal 830 and the user device 832 may communicate via one or more communications protocols (e.g., Bluetooth, Wi-Fi, cellular, radio, through the Internet, wired connection, etc.) through a network (e.g., a CAN bus, the communications network 810, etc.). The user device 832 includes a display (e.g., a screen, etc.) configured to display one or more graphical user interfaces (“GUIs”) of the user portal 830.

As shown in FIG. 4, the remote systems 840 include a first remote system, shown as off-site server 850, and a second remote system, shown as on-site system 860 (e.g., in a clubhouse of a golf course, on the golf course, etc.). In some embodiments, the remote systems 840 include only one of the off-site server 850 or the on-site system 860. As shown in FIG. 4, (a) the off-site server 850 includes a processing circuit 852, a memory 854, and a communications interface 856 and (b) the on-site system 860 includes a processing circuit 862, a memory 864, and a communications interface 866.

According to an exemplary embodiment, the remote systems 840 (e.g., the off-site server 850 and/or the on-site system 860) are configured to communicate with the vehicles 10 and/or the user sensors 820 via the communications network 810. By way of example, the remote systems 840 may receive the vehicle data from the vehicles 10 and/or the operator data from the user sensors 820. The remote systems 840 may be configured to perform back-end processing of the vehicle data and/or the operator data. The remote systems 840 may be configured to monitor various global positioning system (“GPS”) information and/or real-time kinematics (“RTK”) information (e.g., position/location, speed, direction of travel, geofence related information, etc.) regarding the vehicles 10 and/or the user sensors 820. The remote systems 840 may be configured to transmit information, data, commands, and/or instructions to the vehicles 10. By way of example, the remote systems 840 may be configured to transmit GPS data and/or RTK data based on the GPS information and/or RTK information to the vehicles 10 (e.g., which the vehicle control systems 100 may use to make control decisions). By way of another example, the remote systems 840 may send commands or instructions to the vehicles 10 to implement. By way of yet another example, the remote systems 840 may send steering data to the vehicles 10. The vehicle control systems 100 of the vehicles 10 may operate the steering systems 110 of the vehicles 10 to steer the rear tractive assemblies 56 and/or the front tractive assemblies 60 of the vehicles 10 based on the steering data received from the remote systems 840 such that the remote systems 840 may remotely steer the rear tractive assemblies 56 and/or the front tractive assemblies 60 of the vehicles 10.

According to an exemplary embodiment, the remote systems 840 (e.g., the off-site server 850 and/or the on-site system 860) are configured to communicate with the user portal 830 via the communications network 810. By way of example, the user portal 830 may facilitate (a) accessing the remote systems 840 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 840 (e.g., as updates to settings) and/or used for real time control of the vehicles 10 by the remote systems 840.

### Method of Operating Steering System

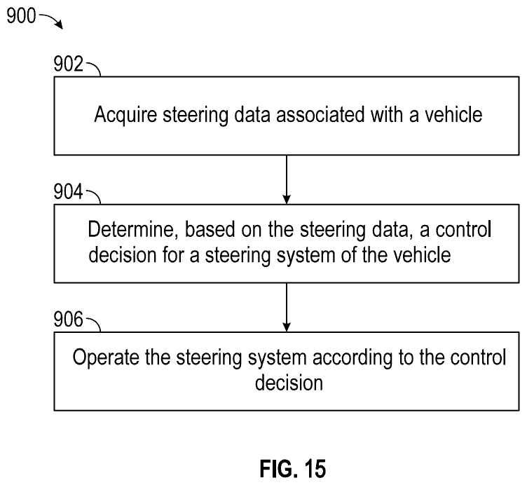

As shown in FIG. 15, a method 900 for operating a steering system of a vehicle includes steps 902-906. The method 900 may be executed by, for example, the vehicle control system 100 of the vehicle 10. Further, any computing device described herein can be configured to perform at least a portion of the method 900 (e.g., the vehicle control system 100, the user device 832, the off-site server 850, the on-site system 860, etc.). According to an exemplary embodiment, the method 900 is for operating a steering system of a vehicle (e.g., the vehicle 10, a golf vehicle, etc.) that is configured to simultaneously steer a front tractive assembly and a rear tractive assembly of the vehicle based on steering data. By way of example, the steering data correspond to an orientation of a steering input device (e.g., a steering wheel, etc.) of the vehicle and may be generated by a sensor associated with the steering wheel such that the steering system is operated based on the orientation of the steering wheel. By way of another example, the steering data may be provided by a remote system configured to autonomously or semi-autonomously steer the vehicle across a golf course such that the steering system is operated based on commands received from the remote system.

As shown in FIG. 15, the method 900 begins with acquiring steering data associated with a vehicle at step 902. In some embodiments, the steering data is acquired from a sensor associated with a steering input device of the vehicle. The sensor may be one of the sensors 90 of the vehicle 10 associated with the steering wheel 42 of the vehicle 10. In such embodiments, the steering data is received by the vehicle control system 100 from the one of the sensors 90 associated with the steering wheel 42. The steering data may be generated by the one of the sensors 90 based on an orientation (e.g., a position, a movement, etc.) of the steering wheel 42. By way of example, when an operator of the vehicle 10 turns the steering wheel 42 from a first orientation to a second orientation, the steering data may correspond with the second orientation of the steering wheel 42. In some embodiments, the steering data is acquired from a remote system associated with the vehicle 10. The remote system may be the remote systems 840 positioned remote or separate from the vehicles 10. The steering data may be generated by the remote systems 840 based on the information available at the remote systems 840. By way of example, the remote systems 840 may generate the steering data based on the vehicle data received from the vehicle 10, the operator data received from the user sensors 820, and/or any other information available to the remote systems 840. By way of another example, the remote systems 840 may generate the steering data based on a first location of the vehicle 10 included in the vehicle data and a second location of the operator included in the operator data. The remote systems 840 may generate the steering data to steer the steering system 110 such that the vehicle 10 travels from the first location to the second location to allow for the operator to access the vehicle 10. In other embodiments, the steering data is generated by a vehicle controller of the vehicle. The vehicle controller may be the vehicle control system 100 of the vehicle 10. By way of example, the vehicle control system 100 may generate the steering data based on the vehicle data acquired from the sensors 90 of the vehicle 10.

As shown in FIG. 15, the method 900 includes determining, based on the steering data, a control decision for a steering system of the vehicle at step 904. In some embodiments, the control decision is for an actuator of the steering system to steer the vehicle. The vehicle control system 100 may determine the control decision for the steer actuator 126 of the steering system 110 based on the steering data. By way of example, the steering data may correspond to steering the vehicle 10 twelve degrees to the right and the vehicle control system 100 may determine a control decision for the steer actuator 126 that will cause the steering system 110 to steer the front tractive assembly 60 and the rear tractive assembly 56 such that the vehicle 10 is steered twelve degrees to the right. By way of another example, the steering data may correspond to the vehicle 10 following a path and the vehicle control system 100 may determine control decisions for the steer actuator 126 that will cause the steering system 110 to steer the front tractive assembly 60 and the rear tractive assembly 56 such that the vehicle 10 is steered to follow the path.

In some embodiments, the step 904 includes determining the control decision for the steering system of the vehicle based on a speed of the vehicle. The vehicle control system 100 may determine the control decision for the steer actuator 126 of the steering system 110 based on the speed of the vehicle. By way of example, the steering data may correspond to steering the vehicle 10 twelve degrees to the right. Responsive to the speed of the vehicle exceeding a vehicle speed threshold, the vehicle control system 100 may determine a control decision for the steer actuator 126 that will cause the steering system 110 to steer the front tractive assembly 60 and the rear tractive assembly 56 such that the vehicle 10 is steered ten degrees to the right instead of twelve degrees to the right in order to prevent flipping of the vehicle 10. In some embodiments, the step 904 includes determining the control decision for the steering system of the vehicle 10 based on a condition of the vehicle. By way of example, the vehicle control system 100 may determine the control decision for the steer actuator 126 of the steering system 110 based on determining that the vehicle 10 may flip. The vehicle control system 100 may determine the control decision for the steer actuator 126 of the steering system 110 to reduce a steering angle of the vehicle 10 such that the vehicle 10 does not flip.

In some embodiments, the step 904 includes determining the control decision for the steering system of the vehicle based on environmental conditions proximate the vehicle. The environmental conditions may include precipitation, ground conditions, or any other condition that may affect the steering of the vehicle 10. By way of example, the steering data may correspond to steering the vehicle 10 twelve degrees to the right. Responsive to a ground moisture level on a ground supporting the vehicle 10 exceeding a ground moisture threshold, the vehicle control system 100 may determine a control decision for the steer actuator 126 that will cause the steering system 110 to steer the front tractive assembly 60 and the rear tractive assembly 56 such that the vehicle 10 is steered eight degrees to the right instead of twelve degrees to the right in order to prevent the vehicle 10 from damaging the ground (e.g., damaging turf growing on the ground, etc.).

In some embodiments, the step 904 includes determining the control decision for the steering system of the vehicle based a configuration of the vehicle 10. The configuration of the vehicle 10 may include a size of tractive elements of the vehicle 10. The vehicle control system 100 may determine the control decision for the steer actuator 126 of the steering system 110 based on a first size of the rear tractive elements 58 and/or a second size of the front tractive elements 62. By way of example, when the first size of the rear tractive elements 58 is greater than a first wheel size threshold (e.g., in inches, etc.), the rear tractive elements 58 may contact the frame 12 when the rear tractive elements 58 are steered above a turning threshold (e.g., in degrees, etc.). Responsive to the first size of the rear tractive elements 58 exceeding the first wheel size threshold, the vehicle control system 100 may limit the control decision for the steer actuator 126 to control decisions that will not cause the rear tractive elements 58 to be steered over a certain amount of degrees to the right or to the left such that the rear tractive elements 58 are prevented from contacting the frame 12. The same control may apply for the front tractive elements 62. In some embodiments the vehicle control system 100 may determine the first size of the rear tractive elements 58 and/or the second size of the front tractive elements 62 based on inputs received by the vehicle control system 100. By way of example, the vehicle control system 100 may determine the first size of the rear tractive elements 58 and/or the second size of the front tractive elements 62 based on a user input from the operator controls 40.

As shown in FIG. 15, the method 900 includes operating the steering system according to the control decision at step 906. In some embodiments, a vehicle controller provides the control decision to the actuator of the steering system such that the actuator is operating according to the control decision. The vehicle control system 100 may provide the control decision to the steer actuator 126 of the steering system 110 to operate the steer actuator 126 according to the control decision such that the steering of the vehicle 10 corresponds to the steering data. By way of example, when the steering data corresponds with steering the vehicle 10 to the right, the control decision provided to the steer actuator 126 may cause the steer actuator 126 to move the movable body 124 towards the second position to simultaneously pivot the front tractive elements 62 to the right and the rear tractive elements 58 to the left such that the vehicle 10 is steered to the right.

In some embodiments, when the vehicle control system 100 operates the steering system 110 based on the steering data associated with the orientation of the steering wheel 42, a relationship between adjusting the orientation of the steering wheel 42 and operating the steering system 110 to steer the rear tractive assembly 56 and the front tractive assembly 60 is non-linear (e.g., the pivoting of the rear tractive elements 58 and the front tractive elements 62 is not proportional to the adjustment of the orientation of the steering wheel 42, etc.). For example, as the steering wheel 42 is adjusted away from a center steering position (e.g., a position of the steering wheel 42 that results in the vehicle 10 driving straight, etc.), the rear tractive elements 58 and the front tractive elements 62 may pivot relative to the frame 12 at a decreasing rate. In other embodiments, when the vehicle control system 100 operates the steering system 110 based on the steering data associated with the orientation of the steering wheel 42, the relationship between adjusting the orientation of the steering wheel 42 and operating the steering system 110 to steer the rear tractive assembly 56 and the front tractive assembly 60 is linear.

As utilized herein with respect to numerical ranges, the terms “approximately,” “about,”“substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 64, the braking system 70, the sensors 90, the vehicle control system 100, etc.) and the steering system 110 as shown in the various exemplary embodiments is illustrative only. Additionally, any element disclosed in one embodiment may be incorporated or utilized with any other embodiment disclosed herein.

1. A golf vehicle comprising:
a chassis;
a front tractive assembly coupled to the chassis;
a rear tractive assembly coupled to the chassis; and
a steering system comprising:
a front actuator assembly coupled to the front tractive assembly, the front actuator assembly configured to steer the front tractive assembly; and
a rear actuator assembly coupled to the rear tractive assembly, the rear actuator assembly configured to steer the rear tractive assembly.

2. The golf vehicle of claim 1, wherein:
the front tractive assembly includes a plurality of front tractive elements;
the rear tractive assembly includes a plurality of rear tractive elements; and
the steering system is configured to simultaneously pivot the front tractive elements in a first direction while pivoting the rear tractive elements in a second opposing direction.

3. The golf vehicle of claim 2, wherein:
the front actuator assembly includes:
a first movable body; and
a first actuator configured to move the first movable body between a first position and a second position to steer the front tractive assembly; and
the rear actuator assembly includes:
a second movable body; and
a second actuator configured to move the second movable body between a third position and a fourth position to steer the rear tractive assembly.

4. The golf vehicle of claim 3, wherein:
movement of the first movable body in a third direction pivots the front tractive elements in the first direction; and
movement of the second movable body in the third direction pivots the rear tractive elements in the second opposing direction.

5. The golf vehicle of claim 3, wherein:
the plurality of rear tractive elements includes a first tractive element on a first side of the golf vehicle and a second tractive element on an opposing second side of the golf vehicle;
the plurality of front tractive elements includes a third tractive element on the first side of the golf vehicle and a fourth tractive element on the opposing second side of the golf vehicle; and
the steering system includes:
a first steering assembly coupled between a first end of the first movable body and the first tractive element;
a second steering assembly coupled between an opposing second end of the first movable body and the second tractive element;
a third steering assembly coupled between a first end of the second movable body and the third tractive element; and
a fourth steering assembly coupled between an opposing second end of the second movable body and the fourth tractive element.

6. The golf vehicle of claim 5, wherein:
the first steering assembly includes:
a first bar coupled to the first end of the first movable body; and
a first steering knuckle pivotably coupled to the chassis, pivotably coupled to the first bar, and coupled to the first tractive element;
the second steering assembly includes:
a second bar coupled to the opposing second end of the first movable body; and
a second steering knuckle pivotably coupled to the chassis, pivotably coupled to the second bar, and coupled to the second tractive element;
the third steering assembly includes:
a third bar coupled to the first end of the second movable body; and
a third steering knuckle pivotably coupled to the chassis, pivotably coupled to the third bar, and coupled to the third tractive element; and
the fourth steering assembly includes:
a fourth bar coupled to the opposing second end of the second movable body; and
a fourth steering knuckle pivotably coupled to the chassis, pivotably coupled to the fourth bar, and coupled to the fourth tractive element.

7. The golf vehicle of claim 1, wherein:
the front tractive assembly includes a plurality of front tractive elements;
the rear tractive assembly includes a plurality of rear tractive elements; and
the steering system is configured to simultaneously pivot the front tractive elements in a first direction while pivoting the rear tractive elements in the first direction.

8. The golf vehicle of claim 1, further comprising one or more processing circuits configured to:
acquire steering data;
determine, based on the steering data, a control decision for the steering system; and
operate the steering system according to the control decision to steer the front tractive assembly and the rear tractive assembly.

9. The golf vehicle of claim 8, wherein:
the front tractive assembly includes a plurality of front tractive elements;
the rear tractive assembly includes a plurality of rear tractive elements;
the steering data includes at least one of a first size of the plurality of front tractive elements or a second size of the plurality of rear tractive elements; and
the one or more processing circuits are configured to determine the control decision based the at least one of the first size or the second size.

10. The golf vehicle of claim 8, further comprising:
an operator input device associated with the steering system; and
a sensor configured to generate at least a portion of the steering data corresponding to an orientation of the operator input device;
wherein the one or more processing circuits are configured to acquire the steering data from the sensor.

11. The golf vehicle of claim 1, wherein the chassis is symmetric about a lateral central axis.

12. A recreational vehicle comprising:
a chassis;
a front tractive assembly including a first tractive element and a second tractive element;
a rear tractive assembly including a third tractive element and a fourth tractive element; and
a steering system including:
a first movable body movable between a first position and a second position;
a first bar coupled to a first end of the first movable body;
a first steering knuckle pivotably coupled to the chassis, pivotably coupled to the first bar, and coupled to the first tractive element;
a second bar coupled to an opposing second end of the first movable body;
a second steering knuckle pivotably coupled to the chassis, pivotably coupled to the second bar, and coupled to the second tractive element;
a second movable body movable between a third position and a fourth position;
a third bar coupled to a first end of the second movable body;
a third steering knuckle pivotably coupled to the chassis, pivotably coupled to the third bar, and coupled to the third tractive element;
a fourth bar coupled to an opposing second end of the second movable body; and
a fourth steering knuckle pivotably coupled to the chassis, pivotably coupled to the fourth bar, and coupled to the fourth tractive element.

13. The recreational vehicle of claim 12, wherein the chassis is symmetric about a lateral central axis.

14. The recreational vehicle of claim 12, wherein movement of the first movable body and the second movable body in a same direction pivots the front tractive assembly in a first direction and the rear tractive assembly in an opposing second direction.

15. The recreational vehicle of claim 14, further comprising one or more processing circuits configured to:
acquire steering data;
determine, based on the steering data, a control decision for the steering system; and
operate the steering system according to the control decision to steer the front tractive assembly and the rear tractive assembly.

16. The recreational vehicle of claim 15, wherein the steering data includes at least one of (a) a first size of the first tractive element and the second tractive element or (b) a second size of the third tractive element and the fourth tractive element.

17. The recreational vehicle of claim 15, wherein, prior to operating the steering system according to the control decision, the one or more processing circuits are configured to:
determine, based on the control decision, that at least one of the first tractive element, the second tractive element, the third tractive element, or the fourth tractive element will contact the chassis; and
modify the control decision such that the at least one of the first tractive element, the second tractive element, the third tractive element, or the fourth tractive element does not contact the chassis.

18. A steering system for a vehicle, the steering system comprising:
a first actuator assembly;
a second actuator assembly;
a first steering assembly coupled to the first actuator assembly and configured to couple to a first front tractive element of the vehicle on a first side of the vehicle;
a second steering assembly coupled to the first actuator assembly and configured to couple to a second front tractive element of the vehicle on an opposing second side of the vehicle;
a third steering assembly coupled the second actuator assembly and configured to couple to a first rear tractive element of the vehicle on the first side of the vehicle; and
a fourth steering assembly coupled to the second actuator assembly and configured to couple to a second rear tractive element of the vehicle on the opposing second side of the vehicle.

19. The steering system of claim 18, further comprising one or more processing circuits configured to control the first actuator assembly and the second actuator assembly based on a size of the first front tractive element, the second front tractive element, the first rear tractive element, and the second rear tractive element.

20. The steering system of claim 18, wherein:
the first steering assembly includes:
a first bar coupled to the first end of the first actuator assembly; and
a first steering knuckle configured to pivotably couple to a chassis of the vehicle, pivotably coupled to the first bar, and configured to couple to the first front tractive element;
the second steering assembly includes:
a second bar coupled to an opposing second end of the first actuator assembly; and
a second steering knuckle configured to pivotably couple to the chassis, pivotably coupled to the second bar, and configured to couple to the second front tractive element;
the third steering assembly includes:
a third bar coupled to a first end of the second actuator assembly; and
a third steering knuckle configured to pivotably couple to the chassis, pivotably coupled to the third bar, and configured to couple to the first rear tractive element;
the fourth steering assembly includes:
a fourth bar coupled to an opposing second end of the second actuator assembly; and
a fourth steering knuckle configured to pivotably couple to the chassis, pivotably coupled to the fourth bar, and configured to couple to the second rear tractive element; and
moving the first actuator assembly and the second actuator assembly in a same direction pivots the first steering knuckle and the second steering knuckle relative to the chassis in a first rotational direction and the third steering knuckle and the fourth steering knuckle relative to the chassis in an opposing second rotational direction.
